(19) United States
(12) Patent Application Publication
(10) Pub. No.: US 2020/0346972 A1
(43) Pub. Date: Nov. 5, 2020

(54) BASE MATERIAL AND COPOLYMER

(71) Applicant: AGO Inc, Chiyoda-ku (JP)

(72) Inventors: Hajime EGUCHI, Tokyo (JP); Kyoko YAMAMOTO, Tokyo (JP); Ryohei KOGUCHI, Tokyo (JP); Yosuke AMINO, Tokyo (JP); Noriko TANABE, Tokyo (JP)

(73) Assignee: AGO Inc, Chiyoda-ku (JP)

(21) Appl. No.: 16/931,548

(22) Filed: Jul. 17, 2020

Related U.S. Application Data
(63) Continuation of application No. PCT/JP2019/003029, filed on Jan. 29, 2019.

(30) Foreign Application Priority Data
Feb. 1, 2018 (JP) 2018-016738
Jun. 28, 2018 (JP) 2018-123479

(51) Int. Cl. C03C 17/30; C08F 230/08; C09D 143/04; C09D 5/16; A01K 63/00

(52) U.S. Cl. CPC C03C 17/30; C08F 230/08; A01K 63/003; C09D 5/1662; C09D 143/04

(57) ABSTRACT

The present invention relates to a base material that comes into contact with water and contains a base material main body and a surface layer provided on at least a part of a surface that comes into contact with water of the base material main body, (1) in which the surface layer is composed of a cured product of a composition containing a compound having a biocompatible moiety and a reactive silyl group, the biocompatible moiety has a specific structure, the composition has a content of the biocompatible moiety being 25 to 83% by mass and a content of the reactive silyl group being 2 to 70% by mass, in a solid component, or (2) in which the surface layer has an elastic modulus showing a measured value in water being 0.1% to 63% with respect to a measured value after drying in the air.

### TECHNICAL FIELD

The present invention relates to a base material, particularly a base material on which adhesion of algae is suppressed, and a copolymer.

### BACKGROUND ART

In an aquarium for keeping ornamental fish and live fish, algae may be generated in the aquarium during use and adhere to the inner wall surface thereof. Owing to the adhesion of algae to the inner wall surface of the aquarium, there arise problems that the fish in the aquarium cannot be viewed, a bad smell is generated, and the fish are adversely affected, for example. Furthermore, there is a problem that when live fish eat this alga, they have a musty smell when they are cooked and eaten.

On the other hand, heretofore, a variety of antifouling coating agents which prevent dirt from adhering to the surface of an article have been known. As the antifouling coating agent, for example, an oil repellent composed of a fluorine-containing compound, a hydrophilic antifouling coating agent, and the like are known. Regarding the hydrophilic antifouling coating agent, for example, Patent Literature 1 describes a technique of incorporating an antifouling property-imparting composition, which contains an organosilicate and a water-soluble and/or water-dispersible curing agent having a reactive functional group and a hydrophilic group in the molecule, into a water-based paint.

However, even when the antifouling coating agent as described above is used, adhesion of algae to an aquarium cannot be effectively suppressed.

### CITATION LIST

### Patent Literature

Patent Literature 1: JP-A-2006-188591

### SUMMARY OF INVENTION

### Technical Problem

The present invention has been made from the above-described viewpoint, and an object thereof is to provide a base material where adhesion of algae on a surface that comes into contact with water of the base material is suppressed and the suppressing action is durable. Moreover, another object of the present invention is to provide a copolymer that can be used for a surface treatment of a base material for the purpose of suppressing adhesion of algae, for example.

### Solution to Problem

The gist of the present invention includes the following configurations.

[1] A base material that comes into contact with water and contains a base material main body and a surface layer provided on at least a part of a surface that comes into contact with water of the base material main body, in which the surface layer is composed of a cured product of a composition containing a compound having a biocompatible moiety and a reactive silyl group, the biocompatible moiety is composed of at least one selected from the group consisting of a structure represented by the following formula 1, a structure represented by the following formula 2 and a structure represented by the following formula 3, the composition has a content of the biocompatible moiety being 25 to 83% by mass and a content of the reactive silyl group being 2 to 70% by mass, in a solid component, and in the case where the biocompatible moiety has the structure represented by the following formula 1, 50 to 100% by mol of the structure represented by the following formula 1 is a structure represented by the following formula 1 in the structure represented by the following formula 4 (hereinafter referred to as base material of the first aspect).

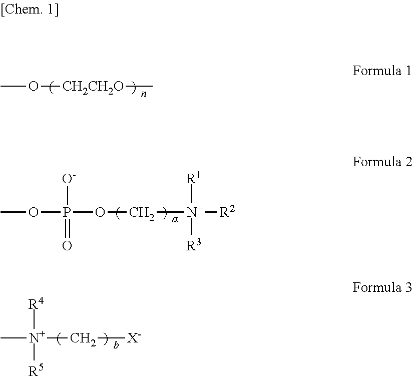

Here, in the formula 1, n is an integer of 1 to 300.

In the formula 2, R¹ to R³ are each independently an alkyl group having a carbon number of 1 to 5, and a is an integer of 1 to 5.

In the formula 3, R⁴ and R⁵ are each independently an alkyl group having a carbon number of 1 to 5, X⁻ is a group represented by the following formula 3-1 or a group represented by the following formula 3-2, and b is an integer of 1 to 5.

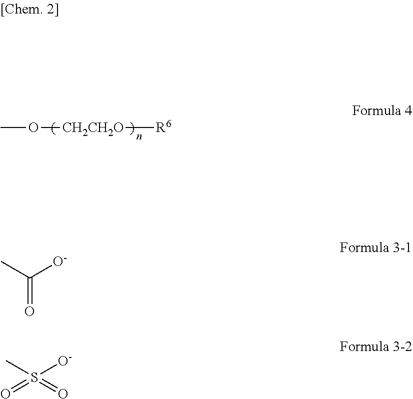

Here, in the formula 4, n is an integer of 1 to 300 and R⁶ is a hydrogen atom or an alkyl group having a carbon number of 1 to 5.

[2] The base material according to [1], in which the compound is a compound where the reactive silyl group is introduced so as to be bonded to a polyoxyethylene polyol or a polyoxyethylene polyol alkyl ether having at least one hydroxyl group (where the alkyl has a carbon number of 1 to 5) via an oxygen atom derived from the hydroxyl group or via a linking group in which the oxygen atom derived from the hydroxyl group is bonded to —(CH₂)ₖ—, —CONH(CH₂)ₖ—, —CON(CH₃)(CH₂)ₖ—, —CON(C₆H₅)(CH₂)ₖ—, —(CF₂)ₖ—, —CO(CH₂)ₖ—, —CH₂CH(—OH)CH₂O(CH₂)ₖ— (k represents an integer of 2 to 4), —CH₂OC₃H₆—, or —CF₂OC₃H₆—.

[3] The base material according to [1], in which the compound is a copolymer having a unit based on a (meth)acrylate having the structure represented by the formula 1 (where 50 to 100% by mol thereof is the structure represented by the formula 1 in the structure represented by the formula 4) and a unit based on a (meth)acrylate having the reactive silyl group.

[4] The base material according to [1] or [3], in which the compound is a copolymer having a unit based on a (meth)acrylate having the structure represented by the formula 1 (where 50 to 100% by mol thereof is the structure represented by the formula 1 in the structure represented by the formula 4), a unit based on a (meth)acrylate having the reactive silyl group and a unit represented by the formula (B12):

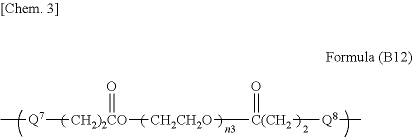

Here, in the formula (B12), Q⁷ and Q⁸ are each independently a divalent organic group, and n3 is an integer of 20 to 200.

[5] The base material according to [1], in which the composition contains: a copolymer having a unit based on a (meth)acrylate having the structure represented by the formula 1 and a unit based on a (meth)acrylate having the reactive silyl group; and a polymer composed only of a unit based on a (meth)acrylate having the structure represented by the formula 1, and 50 to 100% by mol of the structure represented by the formula 1 contained in the solid component of the composition is the structure represented by the formula 1 in the structure represented by the formula 4.

[6] The base material according to [5], in which the base material main body has a constituent material of glass.

[7] An aquarium containing the base material as described in any one of [1] to [6] in at least a part thereof.

[8] A base material that comes into contact with water and contains a base material main body and a surface layer provided on at least a part of a surface that comes into contact with water of the base material main body, in which the surface layer has an elastic modulus measured by an atomic force microscope, and the elastic modulus shows a measured value in water being 0.1% to 63% with respect to a measured value after drying in the air.

[9] An aquarium containing the base material as described in [8] in at least a part thereof.

[10] A copolymer containing a unit represented by the following formula (A), a unit represented by the following formula (B11) and a unit represented by the following formula (B12):

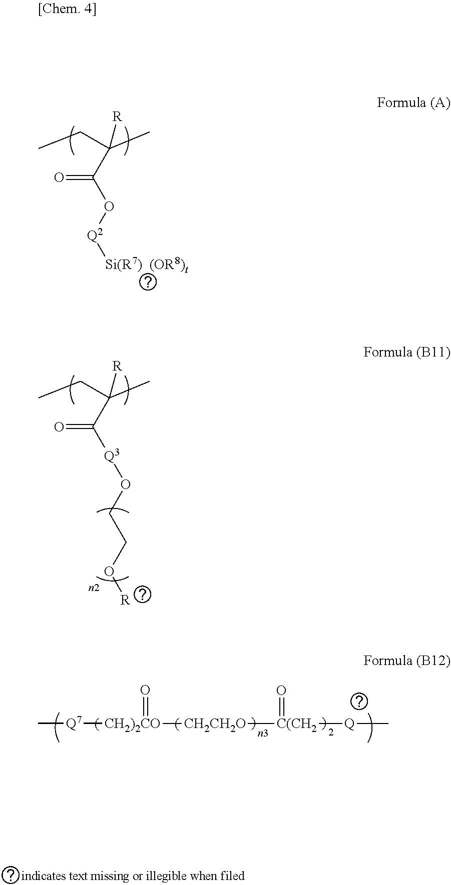

Here, the symbols in the formula (A), the formula (B11) and the formula (B12) are as follows.

In the formulas (A) and (B11), R represents a hydrogen atom or a methyl group.

In the formula (A), Q² is a divalent organic group, R⁷ is an alkyl group having a carbon number of 1 to 18, and R⁸ is a hydrogen atom or an alkyl group having a carbon number of 1 to 18, t is an integer of 1 to 3, and in the case where a plurality of R⁷'s and OR⁸'s are present, the R⁷'s and the R⁸'s may be individually the same as or different from each other.

In the formula (B11), Q³ is a single bond or a divalent organic group, n2 is an integer of 1 to 300, and R⁶ is a hydrogen atom or an alkyl group having a carbon number of 1 to 5.

In the formula (B12), Q⁷ and Q⁸ are each independently a divalent organic group, and n3 is an integer of 20 to 200.

[11] The copolymer according to [10], satisfying a relationship of 1>f1/(f1+j1)≥0.5, when the total number of all units in the copolymer is defined 100 and when the number of units represented by the formula (B11) is denoted f1 and the number of units represented by the formula (B12) is denoted j1.

[12] A composition containing the copolymer as described in [10] or [11].

### Advantageous Effects of Invention

According to the present invention, it is possible to provide a base material where adhesion of algae on a surface that comes into contact with water of the base material is suppressed and the suppressing action is durable. Also, an aquarium having the base material can be provided. Particularly, the effect of the present invention is remarkable in an aquarium for keeping ornamental fish or live fish. Furthermore, the copolymer and the composition of the present invention can be used for a surface treatment of a base material, particularly for a surface treatment for suppressing adhesion of algae.

### BRIEF DESCRIPTION OF DRAWINGS

FIG. 1 is a perspective view schematically illustrating an example of an aquarium of an embodiment of the present invention.

FIG. 2 is a cross-sectional view of the aquarium illustrated in FIG. 1 at the S surface.

FIG. 3 is a planar view of a test plate used for evaluation in Examples.

### DESCRIPTION OF EMBODIMENTS

Hereinafter, embodiments of the present invention will be described. The present invention should not be construed as being limited to the following description. Incidentally, other embodiments may belong to the scope of the present invention as long as they match the gist of the present invention. Furthermore, aspects in which the following embodiments and modified examples are arbitrarily combined are also preferable examples.

In the present description, a compound, a group, a structure, or a unit represented by a chemical formula is also expressed as a compound, a group, a structure, or a unit attached with the number of the formula. For example, a compound represented by the formula 1 is also expressed as a compound 1, and a structure represented by the formula 1 is also expressed as a structure 1.

A “(meth)acrylate” is a collective term for an acrylate and a methacrylate.

A unit in a copolymer means a portion derived from a monomer, formed by polymerizing the monomer. The symbol of a formula used for a unit is also used as the symbol of a monomer. For example, a unit represented by the formula (A) is also expressed as a unit (A), and a monomer forming the unit (A) by polymerization is also expressed as a monomer (A).

A “reactive silyl group” is a collective term for a hydrolyzable silyl group such as an alkoxysilyl group and a silanol group.

The base material of the present invention is a base material that comes into contact with water, and has a base material main body and a surface layer provided on at least a part of the surface that comes into contact with water of the base material main body.

The base material of the first aspect of the present invention has a surface layer disposed on at least a part of the surface that comes into contact with water of the base material main body. The surface layer is composed of a cured product of a composition (hereinafter referred to as composition (Y)) containing a compound (hereinafter referred to as compound (X)) having a biocompatible moiety composed of at least one selected from the group consisting of a structure represented by the above-described formula 1, a structure represented by the above-described formula 2 and a structure represented by the above-described formula 3 and a reactive silyl group, in which the content of the biocompatible moiety is 25 to 83% by mass and the content of the reactive silyl group is 2 to 70% by mass in a solid component of the composition, and in the case where the biocompatible moiety has the structure represented by the above-described formula 1, 50 to 100% by mol of the structure represented by the above-described formula 1 is a structure represented by the above-described formula 1 in a structure represented by the above-described formula 4.

The solid component in the composition refers to a residual component obtained by vacuum-drying the composition at 80° C. for 3 hours to remove volatile components. The cured product of the composition is a cured product of the solid component. Furthermore, in the following description, unless otherwise specified, the “biocompatible moiety” is a biocompatible moiety composed of at least one selected from the group consisting of the structure represented by the above-described formula 1, the structure represented by the above-described formula 2 and the structure represented by the above-described formula 3.

Since the base material according to the first aspect of the present invention has a surface layer composed of a cured product obtained by using the composition (Y) containing the compound (X) on the surface that comes into contact with water of the base material main body, adherence of algae is suppressed and the effect is maintained. It is considered that since the composition (Y) has a sufficient amount of the biocompatible moiety, the obtained cured product also has a sufficient amount of the biocompatible moiety, and that adhesion of algae is effectively suppressed by the inclusion of water in the biocompatible moiety. Furthermore, it is also considered that since the composition (Y) has a predetermined amount of the reactive silyl group, the reactive silyl group is firmly bonded to the surface of the base material at the time when the composition (Y) is cured and hence the effect of suppressing adhesion of algae is maintained. Hereinafter, the action of suppressing adhesion of algae is also referred to as “alga resistance”.

Here, the compound (X) contained in the composition (Y) has both the biocompatible moiety and the reactive silyl group, which greatly contributes to the effect of maintaining the effect of suppressing adhesion of algae in the composition (Y). That is, the compound (X) has the reactive silyl group, and the hydrolyzable silyl group undergoes a hydrolysis reaction to form a silanol group (Si—OH), or the compound has a silanol group. Then, the silanol groups are dehydrated and condensed with each other to form a siloxane bond (Si—O—Si), thus forming a cured product. At this time, also in the case where the composition (Y) contains a reactive silyl group-containing component other than the compound (X), the component and the compound (X) similarly form a siloxane bond. Since the siloxane bond can form a three-dimensional matrix structure, it is considered that in the case where the composition (Y) contains a biocompatible moiety-containing component other than the compound (X), the component is retained in the three-dimensional matrix structure.

In the case where the composition (Y) containing the compound (X) is cured on the surface of the base material main body, the silanol group generated by the hydrolysis reaction of the reactive silyl group-containing component including the compound (X) is, concurrently with the formation of the Si—O—Si bond, dehydrated and condensed with the hydroxyl group (base material-OH) on the surface of the base material main body to form a chemical bond (base material-O—Si). Accordingly, the obtained surface layer firmly adheres to the surface of the base material main body, and thus has high durability, for example, water resistance.

The base material of the present invention has a surface that comes into contact with water. The base material having such a surface is specifically applicable to aquariums, pipes, waterways, pools, ship bottoms, and overflow plates. In particular, it is preferably applied to a place which is exposed to light and where algae easily adhere and grow. The base material is especially preferably used for an aquarium.

The aquarium to be targeted by the present invention is not particularly limited as long as it is an aquarium capable of housing water. Regardless of the type of the aquarium, the problem of algae adhesion to the surface that comes into contact with water may occur. In particular, the aquarium where algae are likely to be generated is an aquarium having such a configuration that at least a part of a water-housing portion of the aquarium transmits light. Furthermore, in an aquarium for keeping ornamental or edible living organisms, owing to feeds, fertilizers for aquatic plants, excrement of the living organisms, and the like, water is polluted and the environment becomes one where algae are easily generated. The present invention can exert the effect particularly in an aquarium having such a configuration or application that algae are easily generated.

In addition, in the aquarium of the present invention, the constituent components of the surface layer themselves do not adversely affect living organisms, and substances that adversely affect living organisms are hardly eluted even when they come into contact with water. Therefore, the aquarium of the present invention is also advantageous from the viewpoint of safety at the time when used as an aquarium for keeping ornamental or edible living organisms.

In the present invention, the type of alga that can be suppressed from adhering is not limited as long as it is an alga that generally grows in an aquarium. Examples thereof include diatoms, green algae, blue-green algae, water-bloom, and the like.

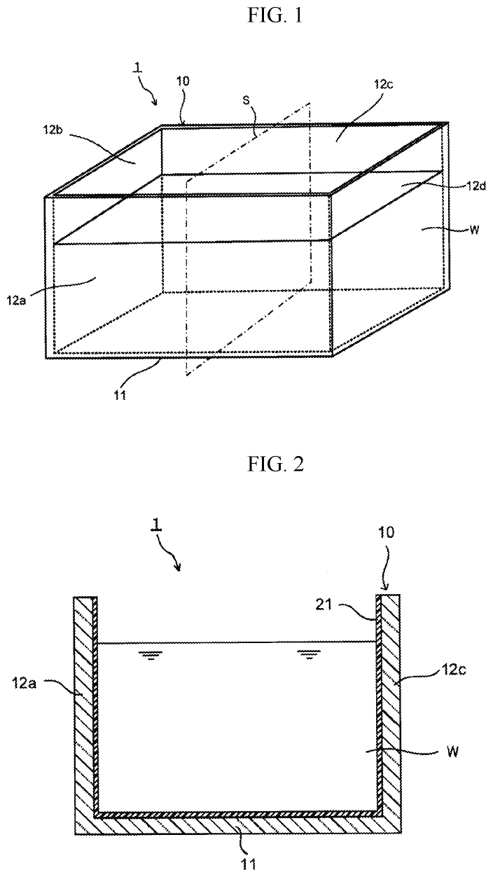

Hereinafter, an aquarium using the base material according to the first aspect of the present invention will be described with reference to the drawings. FIG. 1 is a perspective view schematically illustrating an example of the aquarium of the embodiment, and FIG. 2 is a cross-sectional view of the aquarium illustrated in FIG. 1 at the S surface. The aquarium illustrated in FIGS. 1 and 2 is, for example, an aquarium used for ornamental fish, but the use application of the aquarium of the present invention is not limited thereto, and the shape of the aquarium can be appropriately changed depending on the use application.

The aquarium (base material) 1 illustrated in FIGS. 1 and 2 includes an aquarium main body (base material main body) 10 having the following shape and a surface layer 21 provided on the inner surface of the aquarium main body 10. The aquarium main body 10 is composed of a rectangular bottom plate 11 and four wall plates 12a to 12d that stand upright from the peripheral edges of the bottom plate 11 toward the upper part of opening (hereinafter, the wall plates are collectively denoted by a reference numeral 12), and the upper inner edges of the four wall plates 12 form an opening part. The bottom plate 11 and the four wall plates 12 are closely adhered to each other without a gap, and the upper surface of the bottom plate 11 and the inner surfaces of the wall plates 12 form a cavity capable of housing water.

In the aquarium main body 10, the bottom plate 11 and the four wall plates 12 are closely adhered and integrated at their end faces. The aquarium 1 has a surface layer 21 on the upper surface of the bottom plate 11 and on the entire inner surfaces of the wall plates 12 of the aquarium main body 10. In the aquarium, the area where the surface layer 21 is formed is not limited to the area illustrated by the aquarium 1. For example, the surface layer 21 may not be formed on the upper surface of the bottom plate 11 in such a case where the bottom of the aquarium is covered with gravel or the like. Furthermore, in the case where the water level of the water W housed in the aquarium 1 is controlled so as not to exceed a predetermined position, the aquarium may have such a configuration that the surface layer 21 is not disposed in areas above the predetermined position on the inner surfaces of the wall plates 12.

The constituent material of the base material main body is not particularly limited. Specific examples of the constituent material of the base material main body include metals, resins, glasses, and composite materials of two or more thereof, which are appropriately selected depending on the use application. From the viewpoint of adhesiveness to the surface layer, the constituent material of the base material main body of the present invention is preferably such a material that the base material surface composed of the material has a hydroxyl group, and glass is preferred. In the case where the surface of the base material has no hydroxyl group, it is preferred that a hydroxyl group is introduced by a conventionally known method, for example, a physical treatment method such as a corona treatment or a chemical treatment method such as a primer treatment.

As the primer treatment, a method using an alkoxysilyl group-containing compound such as tetraethoxysilane or a partially hydrolyzed condensate thereof, or a method using a metal oxide such as silica is preferred. Either wet coating or dry coating may be used for the primer treatment method.

The surface layer of the base material is composed of the cured product of the composition (Y) containing the compound (X). The compound (X) has the biocompatible moiety composed of at least one selected from the group consisting of the structure represented by the formula 1, the structure represented by the formula 2 and the structure represented by the formula 3, and the reactive silyl group.

The composition (Y) contains 25 to 83% by mass of the biocompatible moiety and 2 to 70% by mass of the reactive silyl group in the solid component.

Furthermore, in the composition (Y), in the case where the biocompatible moiety has the structure represented by the formula 1, 50 to 100% by mol of the structure represented by the formula 1 is the structure represented by the formula 1 in the structure represented by the formula 4. That is, the structure represented by the formula 1 in the structure represented by the formula 4 accounts for 50 to 100% by mol of the total structure represented by the formula 1.

The fact that the structure of the formula 1 is included in the structure of the formula 4 means high fluidity of the polyethylene glycol chain in water, which is preferable from the viewpoint of biocompatibility owing to an excluded volume effect.

The composition (Y) may contain only the compound (X) as the solid component, or may contain a solid component other than the compound (X). In the case where the composition (Y) contains only the compound (X) as the solid component, the compound (X) contains the biocompatible moiety in a proportion of 25 to 83% by mass and the reactive silyl group in a proportion of 2 to 70% by mass. In the case where the composition (Y) contains a component other than the compound (X) as a solid component, the contents of the biocompatible moiety and the reactive silyl group in the compound (X) are appropriately adjusted depending on the group(s) contained in the other component and on the composition.

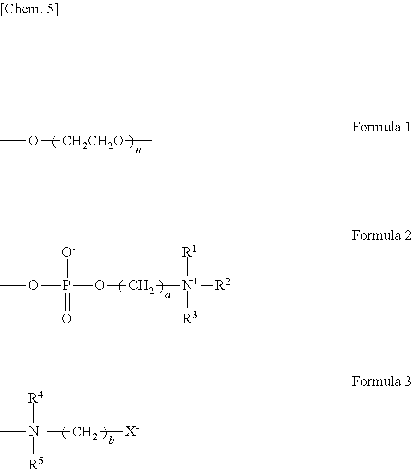

Here, in the formula 1, n is an integer of 1 to 300.

In the formula 2, R¹ to R³ are each independently an alkyl group having a carbon number of 1 to 5, and a is an integer of 1 to 5.

In the formula 3, R⁴ and R⁵ are each independently an alkyl group having a carbon number of 1 to 5, X⁻ is a group represented by the following formula 3-1 or a group represented by the following formula 3-2, and b is an integer of 1 to 5.

In the formula 4, n is an integer of 1 to 300, and R⁶ is a hydrogen atom or an alkyl group having a carbon number of 1 to 5.

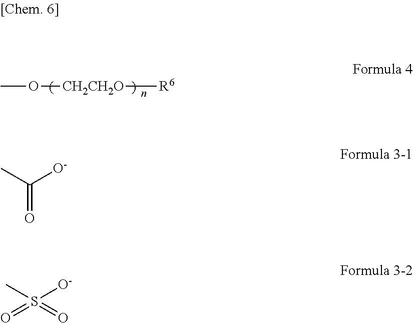

In the present description, the alkyl group and the alkylene group may be linear, branched or cyclic one, or may be a combination thereof.

The biocompatible moiety of the compound (X) is composed of at least one selected from the structure 1, the structure 2 and the structure 3. Hereinafter, the structure 1 in the structure 4 is referred to as “structure 1(4)”. The biocompatible moiety may be composed only of one of the structure 1, the structure 2 and the structure 3, and may be composed of two or more thereof. The structure 1 is preferred as the biocompatible moiety.

The reactive silyl group of the compound (X) is preferably an alkoxysilyl group, and examples thereof include groups represented by the formula 5.

—Si(R⁷)₃₋ₜ(OR⁸)ₜ Formula 5

Here, in the formula 5, R⁷ is an alkyl group having a carbon number of 1 to 18, R⁸ is a hydrogen atom or an alkyl group having a carbon number of 1 to 18, and t is an integer of 1 to 3. In the case where a plurality of R⁷'s and OR⁸'s are present, the R⁷'s and the R⁸'s may be individually the same as or different from each other. From the viewpoint of production, they are preferably the same.

From the viewpoint of adhesiveness between the base material main body and the surface layer, t is preferably 2 or more, more preferably 3. From the viewpoint of steric hindrance during the condensation reaction, R⁷ is preferably an alkyl group having a carbon number of 1 to 6 and more preferably a methyl group or an ethyl group. From the viewpoint of the hydrolysis reaction rate and the volatility of by-products in the hydrolysis reaction, R⁸ is preferably an alkyl group having a carbon number of 1 to 6 and more preferably a methyl group or an ethyl group.

Examples of the compound (X) include compounds satisfying the requirements as the compound (X), such as a compound (X1) having a polyoxyethylene chain as a main chain and having a reactive silyl group at a terminal or a side chain, a compound (X2) having a hydrocarbon chain obtained by polymerizing an ethylenic double bond as a main chain and having a biocompatible moiety and a reactive silyl group in a side chain, a compound (X3) whose main chain contains both a hydrocarbon chain obtained by polymerizing an ethylenic double bond and a polyoxyethylene chain and which has a biocompatible moiety and a reactive silyl group in a side chain.

The compound (X1) can be obtained by, for example, introducing a reactive silyl group into a polyoxyethylene polyol or a polyoxyethylene polyol alkyl ether having at least one hydroxyl group (where the alkyl has a carbon number of 1 to 5), that is, into the hydroxyl group contained in these compounds, optionally via a linking group. More specifically, the compound (X1) is obtained by, for example, reacting a polyoxyalkylene polyol containing a polyoxyethylene chain or a polyoxyalkylene polyol alkyl ether containing a polyoxyethylene chain and having at least one hydroxyl group (where the alkyl has a carbon number of 1 to 5) with a silane compound (hereinafter, also referred to as a silane compound (S)) having a group reactive to a hydroxyl group and a reactive silyl group (alkoxysilyl group, etc.) in a predetermined ratio.

In other words, the compound (X1) is a compound in which a reactive silyl group is introduced into a polyoxyethylene polyol or a polyoxyethylene polyol alkyl ether having at least one hydroxyl group (where the alkyl has a carbon number of 1 to 5) so that they are bonded to each other via an oxygen atom derived from the hydroxyl group or via a linking group in which an oxygen atom derived from the hydroxyl group and a predetermined group are bonded to each other. Examples of the predetermined group include the same groups as Q¹ in the formula (X11) to be described later.

Examples of the polyoxyalkylene polyol to be used include compounds obtained by ring-opening addition polymerization of an alkylene monoepoxide containing at least ethylene oxide with respect to a relatively low-molecular-weight polyol such as an alkane polyol, an ethereal oxygen atom-containing polyol or a sugar alcohol. Examples of the oxyalkylene group in the polyoxyalkylene polyol include an oxyethylene group, an oxypropylene group, an oxy-1,2-butylene group, an oxy-2,3-butylene group, an oxyisobutylene group, and the like.

Examples of the polyoxyalkylene polyol alkyl ether to be used include compounds in which a part of the hydroxyl groups of such a polyoxyalkylene polyol is ether-bonded to an aliphatic alcohol having a carbon number of 1 to 5. In the following description, unless otherwise specified, the “polyoxyalkylene polyol alkyl ether” is referred to a polyoxyalkylene polyol alkyl ether having at least one hydroxyl group (where the alkyl has a carbon number of 1 to 5). The same shall apply in the case where “oxyalkylene” is changed to “oxyethylene”.

The oxyalkylene group contained in the polyoxyalkylene polyol and the polyoxyalkylene polyol alkyl ether may be composed only of an oxyethylene group, and may be composed of a combination of an oxyethylene group and another oxyalkylene group. From the viewpoint of easiness of molecular design as the compound (X1), a polyoxyethylene polyol or polyoxyethylene polyol alkyl ether having only an oxyethylene group is preferable. Hereinafter, the polyoxyethylene polyol and the polyoxyethylene polyol alkyl ether may be collectively referred to as “polyoxyethylene polyol or the like”.

That is, the compound (X1) is preferably a reaction product of a polyoxyethylene polyol or the like and a silane compound (S). The number of the hydroxyl groups in the polyoxyethylene polyol or the like may be 1 to 6, and from the viewpoint of easiness of molecular design as the compound (X1), is preferably 1 to 4 and particularly preferably 1 to 3. Specific examples of the polyoxyethylene polyol or the like include polyoxyethylene glycol, polyoxyethylene glyceryl ether, trimethylolpropane trioxyethylene ether, pentaerythritol polyoxyethylene ether, dipentaerythritol polyoxyethylene ether, polyoxyethylene glycol monoalkyl ether (where the alkyl has a carbon number of 1 to 5), and the like.

For example, in the case where the polyoxyethylene polyol or the like is a polyoxyethylene glycol having the number of hydroxyl groups of 2, examples of the compound (X1) include compounds represented by the formula (X11), which are obtained by reacting a polyoxyethylene glycol with a silane compound (S1) represented by R⁹-Q¹¹-Si(R⁷)₃₋ₜ(OR⁸)ₜ in the following scheme.

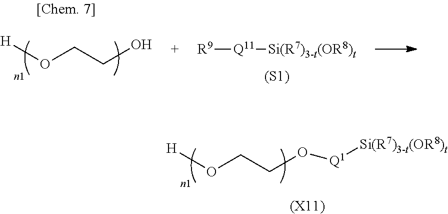

In the above-mentioned reaction scheme, n1 in the polyoxyethylene glycol is an integer of 1 to 300, preferably 2 to 100 and more preferably 4 to 20. R⁷, R⁸ and t in the silane compound (S1) are the same as in the case of the above formula 5 including preferable embodiments. R⁹ in the silane compound (S1) is a group reactive with a hydroxyl group, and examples thereof include a hydroxyl group, a carboxyl group, an isocyanate group, and an epoxy group. Q¹¹ is a divalent hydrocarbon group having a carbon number of 2 to 20, which may have an ethereal oxygen atom between a carbon atom and a carbon atom, and a hydrogen atom may be replaced by a halogen atom such as a chlorine atom or a fluorine atom, or a hydroxyl group. In the case where a hydrogen atom is replaced by a hydroxyl group, the number of the hydroxyl groups to be replaced is preferably 1 to 5.

In the formula (X11), Q¹ is a residual group obtained by reacting R⁹-Q¹¹ of the silane compound (S1) with a hydroxyl group of the polyoxyethylene glycol, and can be expressed as R^{9′}-Q¹¹ (R^{9′} is present on the side bound to O and Q¹¹ on the side to be bonded to the reactive silyl group). Examples of R^{9′} include, corresponding to R⁹, a single bond, —C(═O)—, —C(═O)NH—, and —CH₂CH(—OH)CH₂O—. Hereinafter, —C(═O)N . . . is shown as —CON . . . . For example, —C(═O)NH— is shown as —CONH—.

Examples of Q¹ include, preferably —(CH₂)ₖ—, —CONH(CH₂)ₖ—, —CON(CH₃)(CH₂)ₖ—, —CON(C₆H₅)(CH₂)ₖ—, —(CF₂)ₖ—, —CO(CH₂)ₖ—, —CH₂CH(—OH)CH₂O(CH₂)ₖ— (k represents an integer of 2 to 4), —CH₂OC₃H₆—, and —CF₂OC₃H₆—, and more preferably —(CH₂)ₖ—, —CONH(CH₂)ₖ—, —(CF₂)ₖ— (k represents an integer of 2 to 4), —CH₂OC₃H₆—, —CF₂OC₃H₆—, and the like. Of these, any one selected from —CONHC₃H₆—, —CONHC₂H₄—, —CH₂OC₃H₆—, —CF₂OC₃H₆—, —C₂H₄—, —C₃H₆—, and —C₂F₄— is more preferable. Furthermore, —CONHC₃H₆—, —CONHC₂H₄—, —C₂H₄—, and —C₃H₆— are preferable.

The compound (X11) may be obtained by reacting a polyoxyethylene glycol with an allyl chloride under basic conditions, followed by a silane modification by a hydrosilylation reaction.

In the compound (X11), the proportion of the structure 1(4) in the structure 1 is 100% by mol. That is, the structure 1 in the compound (X11) is all composed of the structure 1 in the structure 4. As described above, in the compound (X1), the ratio of the oxyethylene chain having R⁶ at one end is preferably a half or more, and in the compound (X11), one end of the oxyethylene chain is all composed of R⁶ (a hydrogen atom in this case).

The content of the biocompatible moiety in the compound (X11) represents % by mass of —ₙ₁(OCH₂CH₂)—O— in the formula (X11), and the content of the reactive silyl group represents % by mass of —Si(R⁷)₃₋ₜ(OR⁸)ₜ in the formula (X11). The contents of the biocompatible moiety and the reactive silyl group in the compound (X11) are appropriately adjusted according to the solid component composition of the composition (Y). The content of the biocompatible moiety in the compound (X11) is, for example, preferably 10 to 90% by mass, more preferably 25 to 83% by mass, further preferably 40 to 83% by mass, and particularly preferably 60 to 83% by mass. The content of the reactive silyl group in the compound (X11) is preferably 1 to 70% by mass, more preferably 2 to 70% by mass, further preferably 2 to 45% by mass, and particularly preferably 10 to 30% by mass.

A compound in which the terminal hydrogen atom in the compound (X11) is replaced by R⁶ other than a hydrogen atom can also be used as the compound (X1). That is, a compound obtained by using a polyoxyethylene glycol monoalkyl ether (where the alkyl is R⁶) instead of the polyoxyethylene glycol having 2 hydroxyl groups in the above-described reaction scheme can also be used as the compound (X1). In that case, R⁶ is preferably a methyl group or an ethyl group and more preferably a methyl group.

For example, in the case where the polyoxyethylene polyol is a polyoxyethylene glyceryl ether having the number of hydroxyl groups of 3, examples of the compound (X1) include compounds represented by the formula (X12), which are obtained by reacting a polyoxyethylene glyceryl ether with a silane compound (S1) represented by R⁹-Q¹¹-Si(R⁷)₃₋ₜ (OR⁸)ₜ, in the following scheme.

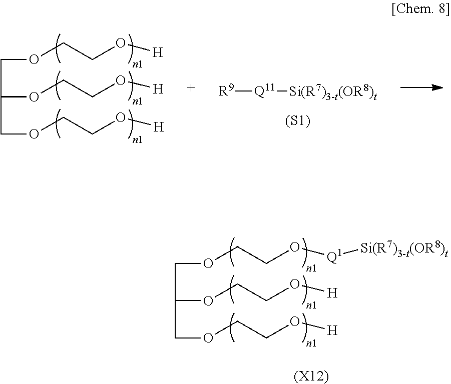

In the above-mentioned reaction scheme, n1 in the polyoxyethylene glyceryl ether is the same as n1 in the polyoxyethylene glycol, including the preferable embodiment. The silane compound (S1) is the same as described above. Q¹ in the compound (X12) is the same as Q¹ in the compound (X11), including the preferable embodiments.

In the compound (X12), the proportion of the structure 1(4) in the structure 1 is 67% by mol. The contents of the biocompatible moiety and the reactive silyl group in the compound (X12) are the same as in the case of the compound (X11), including the preferred embodiments.

A compound in which the terminal hydrogen atom of O—(CH₂CH₂O)ₙ₁—H in the compound (X12) is replaced by R⁶ other than a hydrogen atom can also be used as the compound (X1). In that case, R⁶ is preferably a methyl group.

In the compound (X1), the content of the structure other than the biocompatible moiety and the reactive silyl group is preferably 10 to 50% by mass and more preferably 20 to 30% by mass, from the viewpoint of simultaneously achieving prevention of adhesion of algae and water resistance. The weight-average molecular weight (hereinafter sometimes referred to as “Mw”) of the compound (X1) is preferably 100 to 10,000 and more preferably 500 to 2,000, from the viewpoint of easy availability of raw materials. Mw of the compound (X1) can be calculated by size exclusion chromatography.

The compound (X1) has been described above by taking the polyoxyethylene glycol and the polyoxyethylene glyceryl ether as examples of the polyoxyethylene polyol or the like. Similarly, for a polyoxyethylene polyol or the like other than these, the compound (X1) can be produced while appropriately adjusting the proportion of the structure 1(4) in the structure 1, the content of the biocompatible moiety, the content of the reactive silyl group, and the like to desired proportions.

Furthermore, the compound (X1) may be a partially hydrolyzed condensate thereof. In the case where the compound (X1) is a partially hydrolyzed condensate, the degree of condensation is appropriately adjusted so as to have a viscosity such that it does not hinder the formation of the surface layer on the surface of the base material main body as described below. From such a viewpoint of viscosity, Mw of the partially hydrolyzed condensate is preferably 1,000 to 1,000,000 and more preferably 1,000 to 100,000. The preferable range of Mw is the same for the partially hydrolyzed co-condensates described below. The content (% by mass) of the reactive silyl group in the partially hydrolyzed condensate is treated as the same as the content (% by mass) of the reactive silyl group of the silane compound as the raw material. In the partially hydrolyzed co-condensate, the content (% by mass) of the reactive silyl group can be calculated from the mixing proportion of the silane compound as the raw material.

The compound (X1) may be a partially hydrolyzed co-condensate obtained by partially hydrolyzing and co-condensing two or more kinds of the compounds (X1) so as to contain a biocompatible moiety and a reactive silyl group in desired proportions. The compound (X1) may be also a partially hydrolyzed co-condensate obtained by partially hydrolyzing and co-condensing the compound (X1) and a reactive silane compound having no biocompatible moiety so that the resulting partially hydrolyzed condensate contains the biocompatible moiety and the reactive silyl group in desired proportions as the compound (X).

Examples of the reactive silane compound having no biocompatible moiety include alkoxysilane compounds represented by the following formula 6.

Si(R²⁰)₄₋ₚ(OR²¹)ₚ Formula 6

Here, in the formula 6, R²⁰ is a monovalent organic group having no polyoxyethylene chain, R²¹ is an alkyl group having a carbon number of 1 to 18, and p is an integer of 1 to 4. In the case where a plurality of R²⁰'s and OR²¹'s are present, the R²⁰'s and the R²¹'s may be individually the same as or different from each other. From the viewpoint of production, they are preferably the same.

Specific examples of R²⁰ include alkyl groups having a carbon number of 1 to 18, and a methyl group is preferable from the viewpoint of steric hindrance at the condensation reaction.

From the viewpoint of the adhesiveness between the base material main body and the surface layer, p is preferably 2 or more, more preferably 3 or 4 and particularly preferably 4. From the viewpoint of the hydrolysis reaction rate and the volatility of by-products at the hydrolysis reaction, R²¹ is preferably an alkyl group having a carbon number of 1 to 6 and more preferably a methyl group or an ethyl group.

Examples of the compound (X2) include (meth)acrylate copolymers obtained by copolymerizing monomers containing indispensably a (meth)acrylate having a biocompatible moiety and a (meth)acrylate having a reactive silyl group and optionally another (meth)acrylate other than these. In this case, in the raw material monomers, the respective content of each of the above (meth)acrylates is adjusted so that the resulting (meth)acrylate copolymer contains the biocompatible moiety and the reactive silyl group in desired proportions as the compound (X).

In other words, the compound (X2) is preferably a copolymer containing a unit based on the (meth)acrylate having a biocompatible moiety and a unit based on the (meth)acrylate having a reactive silyl group in predetermined proportions, and optionally containing a unit based on another (meth)acrylate other than these.

The unit based on the (meth)acrylate having a biocompatible moiety is at least one selected from a unit based on a (meth)acrylate having the structure 1, a unit based on a (meth)acrylate having the structure 2 and a unit based on a (meth)acrylate having the structure 3. Specific examples of these units include units based on (meth)acrylates having the structure 1 in a side chain (hereinafter referred to as unit (B1)), units based on (meth)acrylates represented by the following formula (B2), which has the structure 2, and units based on (meth)acrylates represented by the following formula (B3), which has the structure 3. As the unit (B1), a unit based on a (meth)acrylate represented by the following formula (B11), which has the structure 4, is preferable.

In the above, the unit (B1) is a unit based on a (meth)acrylate having the structure 1. The unit (B1) preferably contains 50 to 100% by mol of the unit (B11). That is, the unit (B1) may contain units other than the unit (B11) in a proportion of 50% by mol or less. Examples of the unit other than the unit (B11) include units having a group other than R⁶ instead of R⁶ in the unit (B11), such as a carbonyl group derived from a bifunctional (meth)acrylate. The proportion of the unit (B11) in the unit (B1) is more preferably 75 to 100% by mol, and it is particularly preferable that all (100% by mol) is composed of the unit (B11). Hereinafter, the monomer that results in the unit (B1) is referred to as (meth)acrylate (B1).

The unit (B1), the unit (B2) and the unit (B3) are collectively referred to as the unit (B).

Moreover, examples of the unit based on the (meth)acrylate having a reactive silyl group include units based on (meth)acrylates represented by the following formula (A).

Furthermore, examples of the unit based on another (meth)acrylate include units based on (meth)acrylates represented by the following formula (C).

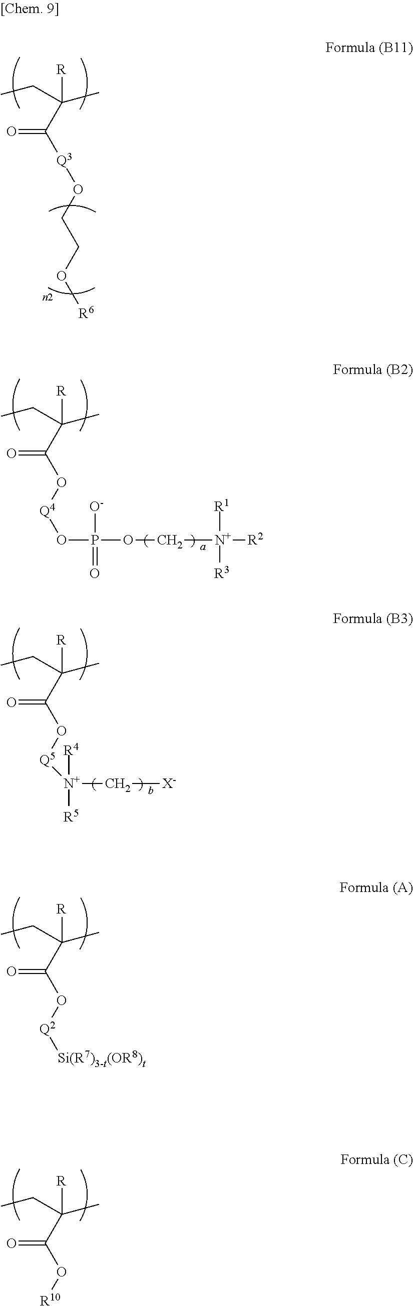

Here, the symbols in the formula (B11), the formula (B2), the formula (B3), the formula (A), and the formula (C) are as follows.

In the formula (B11), the formula (B2), the formula (B3), the formula (A), and the formula (C), R is a hydrogen atom or a methyl group.

In the formula (B11), Q³ is a single bond or a divalent organic group, n2 is an integer of 1 to 300, and R⁶ is a hydrogen atom or an alkyl group having a carbon number of 1 to 5. n2 is preferably 1 to 100 and more preferably 1 to 20.

In the formula (B2), Q⁴ is a divalent organic group, R¹ to R³ are each independently an alkyl group having a carbon number of 1 to 5, and a is an integer of 1 to 5.

In the formula (B3), Q⁵ is a divalent organic group, R⁴ and R⁵ are each independently an alkyl group having a carbon number of 1 to 5, X⁻ is the group 3-1 or the group 3-2, and b is an integer of 1 to 5.

In the formula (A), Q² is a divalent organic group, R⁷ is an alkyl group having a carbon number of 1 to 18, R⁸ is a hydrogen atom or an alkyl group having a carbon number of 1 to 18, t is an integer of 1 to 3, and in the case where a plurality of R⁷'s and OR⁸'s are present, the R⁷'s and the R⁸'s may be individually the same as or different from each other. Preferable embodiments of R⁷, R⁸, and t are the same as those in the above-described formula 5.

In the formula (C), R¹⁶ is a hydrogen atom or a monovalent organic group having no biocompatible moiety and no reactive silyl group. R¹⁰ is preferably a hydrogen atom or an alkyl group having a carbon number of 1 to 100 and more preferably an alkyl group having a carbon number of 1 to 20.

Q², Q⁴ and Q⁵ are each independently preferably a divalent hydrocarbon group having a carbon number of 2 to 10, and may have an ethereal oxygen atom between a carbon atom and a carbon atom, and a hydrogen atom may be replaced by a halogen atom such as a chlorine atom or a fluorine atom, or a hydroxyl group.

Q² is preferably —C₂H₄—, —C₃H₆—, or —C₄H₈—, more preferably —C₃H₆— or —C₄H₈— and further preferably —C₃H₆—.

Q⁴ and Q⁵ are each independently preferably —C₂H₄—, —C₃H₆—, or —C₄H₈—, more preferably —C₂H₄— or —C₃H₆— and further preferably —C₂H₄—.

Q³ is, for example, a single bond or —O-Q⁶-, and Q⁶ is the same as Q². Q³ is preferably a single bond.

Hereinafter, (meth)acrylates to be raw materials of the unit (A), the unit (B11), the unit (B2), the unit (B3), and the unit (C) are exemplified. Incidentally, the (meth)acrylate (B1), the (meth)acrylate (B2) and the (meth)acrylate (B3) are collectively referred to as (meth)acrylate (B). In the following description of the (meth)acrylates, all the meanings of the symbols are the same as above. Furthermore, —C(═O)O . . . is shown as —COO . . . .

The (meth)acrylate (A) is CH₂═CR—COO-Q²-Si(R⁷)₃₋ₜ(OR⁸)ₜ, preferably CH₂═CR—COO-Q²-Si(OR⁸)₃ and particularly preferably CH₂═CR—COO—(CH₂)₃—Si(OCH₃)₃ and CH₂═CR—COO—(CH₂)₃—Si(OC₂H₅)₃.

The (meth)acrylate (B11) is CH₂═CR—CO-Q³-O—(CH₂CH₂O)ₙ₂—R⁶, preferably CH₂═CR—COO—(CH₂CH₂O)ₙ₂—R⁶ (n2=1 to 300, R⁶ is H or CH₃). n2 is more preferably 1 to 20.

The (meth)acrylate (B2) is CH₂═CR—COO-Q⁴-(PO₄⁻)—(CH₂)ₐ—N⁺R¹R²R³, preferably CH₂═CR—COO—(CH₂)₂—(PO₄⁻)—(CH₂)₂—N⁺(CH₃)₃.

The (meth)acrylate (B3) is CH₂═CR—COO-Q⁵-N⁺R⁴R⁵—(CH₂)_{b}—X⁻ and preferably CH₂═CR—COO—(CH₂)₂—N⁺(CH₃)₂—CH₂—COO⁻.

The (meth)acrylate (C) is CH₂═CR—COO—R¹⁰, and examples thereof include methyl methacrylate, butyl methacrylate, dodecyl methacrylate, and the like.

Examples of the compound (X2) using each of the above-described units include copolymers (X21) represented by the following formula (X21). In the copolymer (X21), the main chain is a hydrocarbon chain obtained by polymerizing an ethylenic double bond, and the biocompatible moiety and the reactive silyl group are present in side chains.

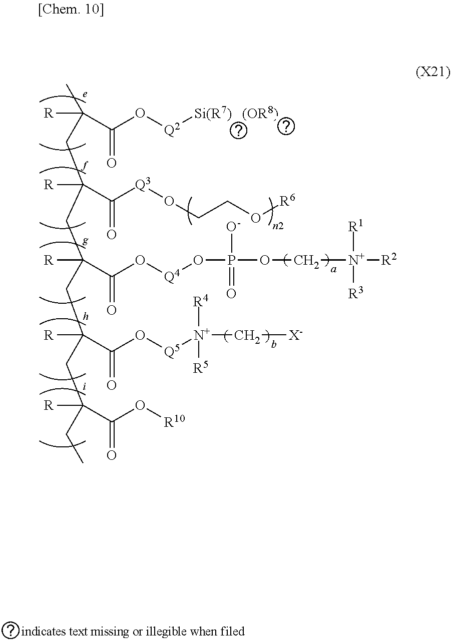

In the formula (X21), e indicates the number of units (A) when the total number of all units in the copolymer (X21) is defined 100. Similarly, f, g, h, and i indicate the numbers of the unit (B11), the unit (B2), the unit (B3), and the unit (C) when the total number of all units in the copolymer is defined 100, respectively. In the copolymer (X21), e>0, f+g+h>0 and i≥0. The symbols other than e to i in the formula (X21) have the same meanings as described above. The copolymer (X21) may be a random copolymer or a block copolymer.

The contents of the biocompatible moiety and the reactive silyl group (—Si(R⁷)₃₋ₜ (OR⁸)ₜ in the copolymer (X21) can be adjusted by adjusting the ratios of e to i in the formula (X21). The ratios of e to i in the copolymer (X21) are appropriately adjusted according to the solid component composition of the composition (Y). The content of the biocompatible moiety in the copolymer (X21) is, for example, preferably 20 to 90% by mass, more preferably 25 to 83% by mass, further preferably 30 to 83% by mass, and particularly preferably 40 to 83% by mass. The content of the reactive silyl group in the copolymer (X21) is preferably 1 to 70% by mass, more preferably 2 to 70% by mass, further preferably 2 to 25% by mass, and particularly preferably 2 to 15% by mass.

The copolymer (X2) is preferably composed only of a unit based on the (meth)acrylate having the structure 1 and a unit based on the (meth)acrylate having a reactive silyl group. Furthermore, the unit based on the (meth)acrylate having the structure 1 preferably contains 50 to 100% by mol of the unit based on the (meth)acrylate having the structure 1(4), and more preferably, it is composed only of the unit based on the (meth)acrylate having the structure 1(4). The copolymer (X21) is preferably composed only of the unit (A) and the unit (B11). In that case, in the formula (X21), i, g and h are 0, and e and f are appropriately adjusted so that the contents of the biocompatible moiety and the reactive silyl group in the copolymer (X21) preferably fall within the above-described ranges.

The copolymer (X21) can be obtained, for example, by preparing raw material (meth)acrylates so that e to i are in the above-described predetermined proportions and copolymerizing them by a conventionally known method such as solution polymerization, bulk polymerization, suspension polymerization, or emulsion polymerization in the presence of a polymerization initiator.

Examples of the polymerization initiator include 2,2′-azobis(4-methoxy-2,4-dimethylvaleronitrile), 2,2′-azobis(2,4-dimethylvaleronitrile), 2,2′-azobisisobutyronitrile, 2,2′-azobis(2-methylbutyronitrile), 1,1′-azobis(cyclohexane-1-carbonitrile), 1-[(1-cyano-1-methylethyl)azo]formamide, 4,4′-azobis(4-cyanovaleric acid), dimethyl 2,2′-azobis(2-methylpropionate), 1,1′-azobis(methyl cyclohexylcarboxylate), 2,2′-azobis[N-(2-hydroxyethyl)-2-methylpropanamide], 2,2′-azobis(N-butyl-2-methylpropionamide), 2,2′-azobis(N-butyl-2-methylpropionamide), 2,2′-azobis[2-(2-imidazolin-2-yl)propane] dihydrochloride, 2,2′-azobis[2-(2-imidazolin-2-yl)propane] disulfate dihydrate, 2,2′-azobis[2-(2-imidazolin-2-yl)propane], 2,2′-azobis(2-methylpropionamidine) dihydrochloride, 2,2′-azobis[N-(2-carboxyethyl)-2-methylpropionamidine] tetrahydrate, 2,2′-azobis(2,4,4-trimethylpentane), t-butyl hydroperoxide, cumene hydroperoxide, 1,1,3,3-tetramethylbutyl hydroperoxide, didodecanoyl peroxide, benzoyl peroxide, 2-ethylhexaneperoxoic acid-1,1,3,3-tetramethylbutyl, 2-ethylperoxyhexanoic acid-t-hexyl, and 2-ethylperoxyhexanoic acid-t-butyl.

From the viewpoint of easy production resulting from half-life temperature, preferred are 2,2′-azobis(2,4-dimethylvaleronitrile), 2,2′-azobisisobutyronitrile, 2,2′-azobis(2-methylbutyronitrile), 4,4′-azobis(4-cyanovaleric acid), dimethyl 2,2′-azobis(2-methylpropionate), 1,1′-azobis(methyl cyclohexylcarboxylate), 2,2′-azobis[2-(2-imidazolin-2-yl)propane] dihydrochloride, 2,2′-azobis[2-(2-imidazolin-2-yl)propane] disulfate dihydrate, 2,2′-azobis[2-(2-imidazolin-2-yl)propane], 2,2′-azobis(2-methylpropionamidine) dihydrochloride, 2,2′-azobis[N-(2-carboxyethyl)-2-methylpropionamidine] tetrahydrate, didodecanoyl peroxide, benzoyl peroxide, 2-ethylhexaneperoxoic acid-1,1,3,3-tetramethylbutyl, 2-ethylperoxyhexanoic acid-t-hexyl, and 2-ethylperoxyhexanoic acid-t-butyl.

Incidentally, in the compound (X2), the content of the structure(s) other than the biocompatible moiety and the reactive silyl group is preferably 15 to 55% by mass and more preferably 15 to 40% by mass, from the viewpoint of simultaneously achieving prevention of adhesion of algae and water resistance. From the viewpoint of easy production, Mw of the compound (X2) is preferably 1,000 to 1,000,000 and more preferably 20,000 to 100,000. Mw of the compound (X2) can be calculated by size exclusion chromatography.

Furthermore, the compound (X2) may be a partially hydrolyzed condensate thereof. In the case where the compound (X2) is the partially hydrolyzed condensate, the degree of condensation is appropriately adjusted so as to have a viscosity such that it does not hinder the formation of the surface layer on the surface of the base material main body as described below. From such a viewpoint of viscosity, Mw of the partially hydrolyzed condensate is preferably 2,000 to 2,000,000 and more preferably 30,000 to 300,000. The preferable range of Mw is the same for the partially hydrolyzed condensate described below.

The compound (X2) may be a partially hydrolyzed co-condensate obtained by partially hydrolyzing and co-condensing two or more kinds of the compounds (X2) so as to contain a biocompatible moiety and a reactive silyl group in desired proportions. The compound (X2) may be also a partially hydrolyzed co-condensate obtained by partially hydrolyzing and co-condensing the compound (X2) with an alkoxysilane compound having no biocompatible moiety so that the resulting partially hydrolyzed condensate contains the biocompatible moiety and the reactive silyl group in desired proportions as the compound (X).

Examples of the compound (X3) include (meth)acrylate copolymers obtained by copolymerizing raw material compounds containing indispensably a (meth)acrylate having a biocompatible moiety, a (meth)acrylate having a reactive silyl group, and a compound capable of introducing a polyoxyethylene chain in the main chain, and optionally another (meth)acrylate other than these. In this case, since the polyoxyethylene chain in the main chain is not the structure 1 in the structure 4, the proportion of the structure 1 in the structure 4 to the total structure 1 in the compound (X3) is adjusted to 50% by mol or more by using the (meth)acrylate having the structure 4 as the (meth)acrylate having the biocompatible moiety. In addition, regarding the raw material compounds, the content of each of the above-mentioned raw material compounds is adjusted so that the obtained (meth)acrylate copolymer contains the biocompatible moiety and the reactive silyl group in desired proportions as the compound (X).

In other words, the compound (X3) is preferably a copolymer containing a unit based on the (meth)acrylate having a biocompatible moiety (provided that a unit based on (meth)acrylate having the structure 4 is indispensable), a unit based on the (meth)acrylate having a reactive silyl group and a unit having a polyoxyethylene chain in the main chain in predetermined ratios, and optionally containing a unit based on another (meth)acrylate other than these.

In the compound (X3), the unit based on the (meth)acrylate having a biocompatible moiety is preferably the above-described unit (B) (provided that the unit (B11) is indispensable) and more preferably the unit (B11).

The unit based on the (meth)acrylate having a reactive silyl group is preferably the above-described unit (A).

The unit having a polyoxyethylene chain in the main chain is preferably a unit represented by the following formula (B12).

The unit based on the other (meth)acrylate is preferably the above-described unit (C).

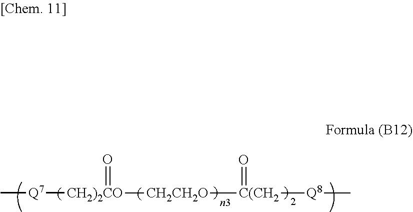

Here, in the formula (B12), Q⁷ and Q⁸ are each independently a divalent organic group, and n3 is an integer of 20 to 200.

Q⁷ and Q⁸ are preferably a divalent hydrocarbon group having a carbon number of 2 to 10, may have an ethereal oxygen atom between a carbon atom and a carbon atom, and a hydrogen atom may be replaced by a halogen atom such as a chlorine atom or a fluorine atom, a hydroxyl group, or a cyano group.

Q⁷ and Q⁸ are preferably —C(CH₃)(COOC₂H₅)—, —C(CH₃)(COOCH₃)—, or —C(CH₃)(CN)—, more preferably —C(CH₃)(COOCH₃)— or —C(CH₃)(CN)— and further preferably —C(CH₃)(CN)—.

n3 is preferably 40 to 200 and more preferably 40 to 140.

Here, the copolymer having the unit (B11), the unit (B12) and the unit (A) (hereinafter, also referred to as copolymer (Z)) is a copolymer of the present invention, which is newly prepared by the present inventors and not described in literatures. The copolymer (Z) has the structure 1 in the unit (B11) and in the unit (B12). The structure 1 in the unit (B11) is the structure 1 in the structure 4, and the structure 1 in the unit (B12) is not the structure 1 in the structure 4. Among the copolymers (Z), a copolymer in which the proportion of the structure 1 in the structure 4 to the total structure 1 is adjusted to 50% by mol or more is within the category of the compound (X3), and can be used for the composition (Y).

In order to adjust the proportion of the structure 1 in the structure 4 to the total structure 1 in the copolymer (Z) to 50% by mol or more, the amounts of the raw material compounds used for the polymerization may be adjusted so that the number of moles of the structure 1 derived from B11 is larger than the number of moles of the structure 1 derived from the unit (B12) in the copolymer.

The copolymer (Z) may have arbitrary units such as the unit (B2), the unit (B3) and the unit (C) in addition to the unit (B11), the unit (B12) and the unit (A). The copolymer (Z) is preferably a copolymer (Z1) represented by the following formula (Z1) having the unit (B11), the unit (B12) and the unit (A), and particularly preferably a copolymer composed only of the unit (B11), the unit (B12) and the unit (A).

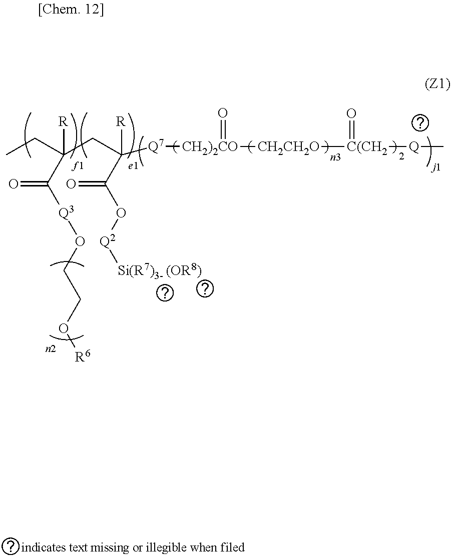

In the formula (Z1), e1 indicates the number of units (A) when the total number of all units of the copolymer (Z1) is defined 100. Similarly, f1 and j1 indicate the numbers of the units (B11) and (B12), respectively, when the total number of all units of the copolymer is defined 100. The symbols in the formula (Z1) other than e1, f1 and j1 have the same meanings as described above. The copolymer (Z1) may be a random copolymer or a block copolymer.

In the case where the copolymer (Z1) is used as the compound (X3), the proportions of f1 and j1 in the formula (Z1) are adjusted so that the requirement of the compound (X3) is satisfied, that is, so that the relation of 1>f1/(f1+j1)≥0.5 is established, and preferably so that the relationship of 1>f1/(f1+j1)≥0.75 is established.

The content of the biocompatible moiety in the compound (X3) is, for example, preferably 20 to 90% by mass, more preferably 25 to 83% by mass, further preferably 30 to 83% by mass, and particularly preferably 40 to 83% by mass.

The content of the reactive silyl group in the compound (X3) is preferably 1 to 70% by mass, more preferably 2 to 70% by mass, further preferably 2 to 25% by mass, and particularly preferably 2 to 15% by mass.

In the case where the copolymer (Z1) is used as the compound (X3), the contents of the biocompatible moiety and the alkoxysilyl group (—Si(R⁷)₃₋ₜ(OR⁸)ₜ) in the copolymer (Z1) can be adjusted to the above-described range preferable for use as the compound (X3) by adjusting the proportions of e1, f1 and j1.

The copolymer (Z) can be obtained, for example, by preparing raw material (meth)acrylates containing the (meth)acrylate (A) and the (meth)acrylate (B11) and a raw material compound to be the unit (B12) so as to be predetermined proportions and copolymerizing them by a conventionally known method such as solution polymerization, bulk polymerization, suspension polymerization, or emulsion polymerization in the presence of a polymerization initiator. In the case where the copolymer (Z) is used as the compound (X3), the proportions of individual units, for example, e1, f1 and j1 in the copolymer (Z1) are appropriately adjusted.

As the raw material compound to be the unit (B12), any compounds containing a polyoxyethylene chain and having radically polymerizable groups at both ends can be mentioned without particular limitation. Furthermore, the raw material compound to be the unit (B12) may be a polymerization initiator containing a polyoxyethylene chain and a radical generating moiety such as an azo group (—N═N—). The case where the raw material compound to be the unit (B12) is a polymerization initiator is preferable because the polyoxyethylene chain can be easily introduced into the main chain of the copolymer. Examples of such a polymerization initiator include azo polymerization initiators having a polyoxyethylene chain. Specific examples thereof include compounds represented by the following formula (PI), and as the compound (PI), VPE-0201 manufactured by Wako Pure Chemical Industries, Ltd. and the like can be mentioned.

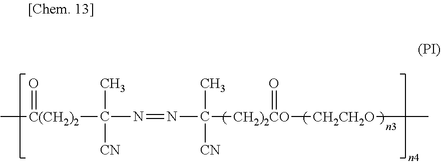

In the formula (PI), n3 is the same as n3 in the formula (B12), and n4 is an integer of 1 to 100. n4 is preferably 2 to 30 and more preferably 3 to 20.

Incidentally, in the compound (X3), preferably in the compound (X3) composed of the copolymer (Z1), the content of the structure(s) other than the biocompatible moiety and the reactive silyl group is preferably 15 to 55% by mass and more preferably 15 to 40% by mass, from the viewpoint of simultaneously achieving prevention of adhesion of algae and water resistance.

Mw of the compound (X3) is preferably 1,000 to 1,000,000 and more preferably 20,000 to 100,000, from the viewpoint of easy production. Mw of the copolymer (Z1) is also the same as Mw of the compound (X3). Mw of the compound (X3) and the copolymer (Z1) can be calculated by size exclusion chromatography.

Furthermore, the compound (X3) may be a partially hydrolyzed condensate thereof. In the case where the compound (X3) is a partially hydrolyzed condensate, the degree of condensation is appropriately adjusted so as to have a viscosity such that it does not hinder the formation of the surface layer on the surface of the base material main body as described later. From such a viewpoint of viscosity, Mw of the partially hydrolyzed condensate is preferably 2,000 to 2,000,000 and more preferably 30,000 to 300,000. The preferable range of Mw is the same for the partially hydrolyzed condensate described below.

The compound (X3) may be a partially hydrolyzed co-condensate obtained by partially hydrolyzing and co-condensing two or more kinds of the compounds (X3) so as to contain the biocompatible moiety and the reactive silyl group in desired proportions. The compound (X3) may be also a partially hydrolyzed co-condensate obtained by partially hydrolyzing and co-condensing the compound (X3) and a reactive silane compound having no biocompatible moiety so that the resulting partially hydrolyzed condensate contains the biocompatible moiety and the reactive silyl group in desired proportions as the compound (X).

The surface layer in the present invention is composed of a cured product of the composition (Y) containing the compound (X). Incidentally, what the surface layer is composed of a cured product of the composition (Y) means that the surface layer contains at least a cured product of the reactive silyl group-containing component containing the compound (X) described above.

The composition (Y) contains the compound (X), and in the solid component of the composition (Y), the content of the biocompatible moiety is 25 to 83% by mass and the content of the reactive silyl group is 2 to 70% by mass.

Since the content of the biocompatible moiety is 25% by mass or more, the obtained surface layer has alga resistance. Since the content of the biocompatible moiety is 83% by mass or less, water resistance can be imparted. The content of the biocompatible moiety in the solid component of the composition (Y) is preferably 30 to 83% by mass and more preferably 40 to 83% by mass.

Since the content of the reactive silyl group is 2% by mass or more, the obtained surface layer has durability, for example, water resistance. Since the content of the reactive silyl group is 70% by mass or less, a sufficient amount of the biocompatible moiety can be introduced. The content of the reactive silyl group in the solid component of the composition (Y) is preferably 2 to 40% by mass and more preferably 2 to 30% by mass.

The composition (Y) may contain one kind of the compound (X) alone or may contain two or more kinds thereof. In the case where two or more kinds of the compound (X) are used, in the case where the compound (X1) is used, two or more kinds thereof are preferably composed only of the compounds (X1). In the case where the compound (X2) and/or the compound (X3) are used, the compound (X) is preferably composed only of two or more selected from the compounds (X2) and the compounds (X3).

In the case where the solid component contained in the composition (Y) is composed only of the compound (X), the compound (X) is selected so that the content of the biocompatible moiety and the content of the reactive silyl group fall within the above-described predetermined ranges. The proportion of the compound (X) in the solid component of the composition (Y) is, for example, preferably 25 to 100% by mass, more preferably 50 to 100% by mass and further preferably 75 to 100% by mass.

The composition (Y) may contain another component other than the compound (X). Examples of the other component include another solid component other than the compound (X), which is contained as solid component in the surface layer. In the case where the surface layer is formed by a dry coating, the composition (Y) contains only solid components. On the other hand, in the case where the surface layer is formed by a wet coating, a liquid medium to be removed at the time of forming the surface layer is further contained as the other component.

The other solid component may be a component that cures similarly to the compound (X) or may be a non-curable component. Examples of the other solid component include compounds having any one of a biocompatible moiety and a reactive silyl group. Further examples of the other solid component include impurities that have not been completely removed from the raw materials used in the production process of the compound (X) and by-products, functional additives, catalysts, and the like. Examples of the functional additives include ultraviolet absorbers, light stabilizers, antioxidants, leveling agents, surfactants, antibacterial agents, dispersants, inorganic fine particles, and the like.

As the catalyst, use can be made of any conventionally known catalyst used for the hydrolysis and condensation reaction of a reactive silyl group, without particular limitation. Specific examples of the catalyst include acids such as hydrochloric acid, nitric acid, acetic acid, sulfuric acid, phosphoric acid, and sulfonic acids such as methanesulfonic acid and p-toluenesulfonic acid, bases such as sodium hydroxide, potassium hydroxide and ammonia, and aluminum-based and titanium-based metal catalysts.

In the case where the compound (X1) is used as the compound (X), an alkoxysilane compound having no biocompatible moiety and/or a partially hydrolyzed condensate thereof may be used as the other solid component. As the alkoxysilane compound having no biocompatible moiety, the above-described compound 6 is preferable. In the case where an alkoxysilane compound having no biocompatible moiety is converted into a partially hydrolyzed condensate, Mw thereof is preferably 100 to 100,000 and more preferably 100 to 10,000.

In the case where the composition (Y) contains the compound (X1) and an alkoxysilane compound having no biocompatible moiety as solid components, the content of the biocompatible moiety is preferably 25 to 83% by mass and the content of the reactive silyl group is preferably 2 to 70% by mass, in the total of the compound (X1) and the alkoxysilane compound having no biocompatible moiety. That is, it is preferable not to contain a compound having a biocompatible moiety and/or a reactive silyl group other than these as the solid components. In this case, the ratio of the alkoxysilane compound having no biocompatible moiety to 100 parts by mass of the compound (X1) is preferably 50 to 200 parts by mass and more preferably 50 to 100 parts by mass.

In the case where the compound (X1) is used as the compound (X), the contents of the other solid components other than the compound (X1), the alkoxysilane compound having no biocompatible moiety and the catalyst in the total solid components is preferably 40% by mass or less and more preferably 20% by mass or less in total, and most preferably the other solid component is not contained.

In the case where the compound (X2) or the compound (X3) is used as the compound (X), a homopolymer of a (meth)acrylate having a biocompatible moiety may be used as the other solid component. The homopolymer of the (meth)acrylate having a biocompatible moiety refers to a polymer in which the units constituting the polymer are composed only of the unit based on the (meth)acrylate having a biocompatible moiety. As the (meth)acrylate having a biocompatible moiety to be used for the homopolymer, a (meth)acrylate having a polyoxyethylene chain is preferable, and a (meth)acrylate having the structure 1(4) is particularly preferable.

In the case where the compound (X2) or the compound (X3) is used in combination with the homopolymer of a (meth)acrylate having a polyoxyethylene chain, it is not necessary to satisfy the requirement of “50 to 100% by mol of the structure 1 is the structure 1 in the structure 4” in each polymer, and it is sufficient that the solid components satisfy the requirement as a whole thereof, that is, in the composition containing them.

For example, in the case where the compound (X2), particularly the copolymer (X21) is used as the compound (X), a homopolymer of the (meth)acrylate (B), further that of the (meth)acrylate (B1) or particularly that of the (meth)acrylate (B11) may be used as the other solid component. Preferred embodiments of the (meth)acrylate (B) to be used for the homopolymer is the same as those described in the copolymer (X21). As the (meth)acrylate (B), the (meth)acrylate (B1) and particularly the (meth)acrylate (B11) is preferable. Mw of the homopolymer of the (meth)acrylate (B) is preferably 1,000 to 1,000,000 and more preferably 20,000 to 100,000.

In the case where the composition (Y) contains the copolymer (X21) and the homopolymer of the (meth)acrylate (B) as the solid components, the content of the biocompatible moiety is preferably 25 to 83% by mass and the content of the reactive silyl group is preferably 2 to 70% by mass, in the total of the copolymer (X21) and the homopolymer of the (meth)acrylate (B). That is, it is preferable not to contain a compound having a biocompatible moiety and/or a reactive silyl group other than these as the solid component. In this case, the ratio of the homopolymer of the (meth)acrylate (B) to 100 parts by mass of the copolymer (X21) is preferably 30 to 100 parts by mass and more preferably 40 to 75 parts by mass.

In the case where the compound (X2) or the compound (X3) is used as the compound (X), the contents of the other solid components other than the compound (X2) or the compound (X3), the homopolymer of the (meth)acrylate (B) and the catalyst in the total solid components is preferably 40% by mass or less and more preferably 20% by mass or less in total, and most preferably the other solid component is not contained.

In the case where the surface layer is formed by a wet coating, the liquid medium contained in the composition (Y) may be any one capable of homogeneously dissolving or dispersing the solid components containing the compound (X), and can be appropriately selected from known various liquid media. Since the liquid medium needs to be finally removed at the time of the formation of the surface layer, the boiling point thereof is in the range of preferably 60 to 160° C. and more preferably 60 to 120° C.

Specific examples of the liquid medium preferably contain alcohols, ethers, ketones, esters, and the like. Specific examples of the liquid medium satisfying the above-described requirement of boiling point include isopropyl alcohol, ethanol, propylene glycol monomethyl ether, 2-butanone, ethyl acetate, and the like. These may be used alone or in combination of two or more thereof.

The liquid medium may contain water for the hydrolysis reaction of the reactive silyl group-containing component including the compound (X), but preferably contains no water from the viewpoint of storage stability. However, even in the case where the liquid medium does not contain water, the reactive silyl group-containing component including the compound (X) can undergo a hydrolysis reaction with moisture in the air, and hence the water contamination in the liquid medium is not essential.

The concentration of the solid components in the composition (Y) in the case where the liquid medium is contained is preferably 0.1 to 50% by mass, more preferably 1 to 30% by mass and further preferably 1 to 15% by mass. In the case where the concentration of the solid components falls within the above-described range, the film thickness of the surface layer formed by wet coating using the composition (Y) tends to fall within a suitable range where the alga resistance and its durability are sufficiently exhibited. The concentration of the solid components of the composition (Y) can be calculated from the mass of the composition (Y) after vacuum drying at 80° C. for 3 hours and the mass of the composition (Y) before heating. It may be calculated from the amounts of the total solid components and the liquid medium that are blended at the time of the production of the composition (Y).

In the case where a liquid medium is contained, the composition (Y) preferably contains the liquid medium in a proportion of preferably 50 to 99.5% by mass, more preferably 65 to 99% by mass and further preferably 70 to 99% by mass.

The method for producing the composition (Y) is not particularly limited. It can be produced by mixing the solid components including the compound (X), or the solid components and a liquid medium in the case where the liquid medium are further contained, so as to achieve the above-described contents. As described above, since the composition (Y) contains the compound (X), has a content of the biocompatible moiety in the solid components being 25 to 83% by mass and has a content of the reactive silyl group being 2 to 70% by mass, the surface layer composed of a cured product of the composition formed on the surface of the base material main body by using the composition (Y) is excellent in alga resistance and also excellent in durability of the alga resistance, especially in water resistance.

The thickness of the surface layer is preferably 10 to 100,000 nm and particularly preferably 10 to 10,000 nm. In the case where the thickness of the surface layer is the lower limit value of the above-described range or more, sufficient alga resistance and durability of the alga resistance, particularly water resistance are easily exhibited. In the case where the thickness of the surface layer is the upper limit value of the above-described range or less, the strength is excellent. The thickness of the surface layer can be determined by measurement on an X-ray reflectance measuring device represented by ATX-G manufactured by Rigaku Corporation.

The base material of the first aspect of the present invention can be obtained by forming a surface layer on the surface of the base material main body by using the composition (Y). The base material main body surface on which the surface layer is formed is as described above. Examples of the method for forming the surface layer include dry coatings such as a vacuum deposition method, a CVD method and a sputtering method, and wet coatings, and a wet coating is preferable.

The present composition can also be used as a repairing agent associated with deterioration of the surface layer of a base material. In that case, the coating method is preferably a wet coating such as spray coating or brush coating. The curing method is preferably heating with a dryer or the like.

The method for forming the surface layer by a wet coating includes a method that contains applying the composition (Y) containing the liquid medium described above to a surface of the base material main body to obtain a coating film (hereinafter, also referred to as “application step”) and curing the coating film to obtain the surface layer (hereinafter, also referred to as “curing step”).

Examples of the method of applying the composition (Y) to a surface of the base material main body in the application step, include a dip coating method, a spin coating method, a wipe coating method, a spray coating method, a squeegee coating method, a die coating method, an inkjet method, a flow coating method, a roll coating method, a casting method, a Langmuir-Blodgett method, a gravure coating method, and the like.

As the method of curing the coating film in the curing step, heating is preferred. The heating temperature depends on the kind of the reactive silyl group-containing component including the compound (X), but is preferably 50 to 150° C. and more preferably 100 to 150° C. Incidentally, in the curing step, the liquid medium is usually removed at the same time. Therefore, the heating temperature is preferably a temperature equal to or higher than the boiling point of the liquid medium. However, in the case where drying under heating is difficult depending on the material of the base material main body or the like, the liquid medium is removed while avoiding the heating. Examples of such a method include vacuum drying and the like.

The formation of the surface layer by a wet coating may include a step for treatment other than the application step and the drying step, if necessary. For example, in the case where the composition (Y) does not contain water, a treatment such as humidification may be performed simultaneously with the curing step or before or after the curing step.

Furthermore, after the formation of the surface layer, excess compounds that are compounds in the surface layer may be removed as needed. Specific examples of the method include a method of pouring a solvent, for example, a compound used as the liquid medium of the composition (Y) onto the surface layer, and a method of wiping with a cloth infiltrated with a solvent, for example, a compound used as the liquid medium of the composition (Y).

In the base material of the first aspect of the present invention, the obtained surface layer has an elastic modulus measured in water of preferably 63% or less, more preferably 50% or less and further preferably 40% or less with respect to the elastic modulus after drying in the air. In the surface layer, the lower limit of the elastic modulus measured in water with respect to the elastic modulus after drying in the air is preferably 0.1%.

The base material of the second aspect of the present invention is a base material that comes into contact with water and contains a base material main body and a surface layer that is provided on at least a part of a surface that comes into contact with water of the base material main body, in which the surface layer has an elastic modulus showing the measured value in water being 0.1% to 63% with respect to the measured value after drying in the air. In the surface state where this value is less than 0.1%, water is excessively contained, thus resulting in insufficient water resistance. Moreover, in the surface state showing a value exceeding 63%, the water content is low and the ability to suppress adhesion of algae becomes insufficient.

In the base material of the second aspect of the present invention, it is considered that it is difficult for algae to adhere to the surface since the elastic modulus of the surface layer has the above-described characteristic. Here, in the base material of the first aspect, the surface of the surface layer has the characteristic of the elastic modulus of the surface in the base material of the second aspect. However, the surface having the characteristic of the elastic modulus of the base material of the second aspect is not limited to the surface of the surface layer of the base material of the first aspect.

In the base material of the second aspect of the present invention, the elastic modulus shows the measured value in water being preferably 0.1% to 50% and more preferably 0.1% to 40% with respect to the measured value after drying in the air. The surface satisfying the characteristic of the elastic modulus can be obtained, for example, by forming a surface layer on the surface of the base material main body in the same manner as in the base material of the first aspect of the present invention, but the method is not limited thereto. Any case where the elastic modulus of the surface layer has the above-described characteristic is within the realm of the base material of the second aspect of the present invention.

In the present description, unless otherwise specified, the elastic modulus means an elastic modulus measured by using an atomic force microscope (AFM).

Incidentally, the measured value of the elastic modulus in water and the measured value after drying in the air specifically refer to the measured values to be measured by the following methods, respectively.

The measured value in water can be measured by using AFM with dropping a phosphate-buffered physiological saline solution on the surface of a measurement target so that a droplet (convex meniscus) is formed.

The measured value after drying in the air can be measured by using AFM under atmospheric conditions after drying the surface of a measurement target under atmospheric pressure under conditions of 30% RH, 25° C. and 60 minutes.

As the AFM to be used for measuring the elastic modulus, for example, use can be made of Cypher-S(Cantilever holder: droplet cantilever holder, Probe: B20-NCHR-base HDCTIP manufactured by German Nanotools, spherical tip, tip curvature: 20 nm, cantilever type: FM-AUD) manufactured by Oxford Instruments.

The following method may be mentioned as a measuring method.

At the time of measuring the elastic modulus, first, the optical lever sensitivity and the spring constant are calibrated by using a sapphire substrate measurement and a thermal noise method. The optical lever sensitivity is calculated by a force curve measurement on a sapphire substrate surface. Furthermore, while the probe is separated from a sample surface by about 1 mm and the calculated optical lever sensitivity is fixed, the spring constant is calculated by a thermal noise method.

Next, the surface shape of a sample is acquired by using the above-described device. Thereafter, the indentation position is determined with avoiding dust and the like, and a force curve measurement is performed. For the measurement, indentation is performed at a maximum pushing force of 200 nN and a pushing rate of 1 Hz. The elastic modulus is calculated by fitting the indentation curve with the Hertz model by using the analysis software (AR ver13) annexed to Cypher-S.

### EXAMPLES

Hereinafter, the present invention will be described in detail with reference to Examples. However, the present invention is not limited by the following description. Unless otherwise specified, “%” indicates “% by mass”. Examples 1 to 5, Examples 15 to 39, and Examples 43 to 44 are Working Examples, and Examples 6 to 14 and Examples 40 to 42 are Comparative Examples.

### (Compound (X1))

The following compounds (X12-1) and (X11-1) were used as the compound (X1). Furthermore, for Comparative Examples, the following compounds (Xcf1) to (Xcf4) not satisfying the requirements as the compound (X) were produced.

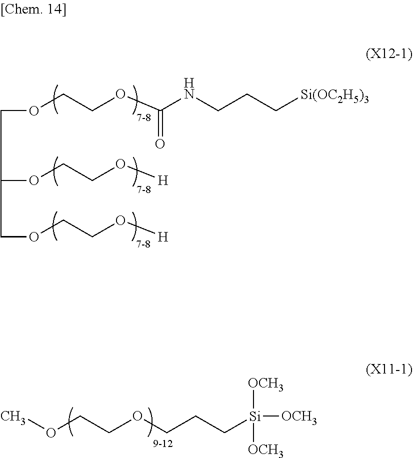

### Production Example 1

The compound (X12-1) is a compound in which n1 is 7 to 8, Q¹ is —CONHC₃H₆—, t is 3, and R⁸ is an ethyl group in the compound (X12). It was synthesized by the following method.

Into a 300 mL-eggplant-shaped flask were added 263 g (259 mmol) of polyoxyethylene glyceryl ether having n1 of 7 to 8 (hereinafter, “polyoxyethylene polyol A”) and 64.1 g (259 mmol) of KBE-9007 (manufactured by Shin-Etsu Silicone Co., Ltd., product name, triethoxysilylpropyl isocyanate). Subsequently, to the obtained mixture was added 3.27 g (32.4 mmol) of 1% by mass trimethylamine, followed by stirring at 80° C. for 16 hours. Then, the obtained reaction mixture was heated under reduced pressure on a rotary evaporator to remove triethylamine, thus obtaining a compound (X12-1) as a colorless transparent liquid. The yield amount was 327 g, and the yield was 100%.

### Production Example 2

As the compound (X11-1), a compound in which a terminal hydrogen atom of the compound (X11) was replaced by a methyl group, n1 was 9 to 12, Q¹ was —C₃H₆—, t was 3, and R⁸ was a methyl group (2-[methoxy(polyoxyethylene)₉₋₁₂propyl]trimethoxysilane, manufactured by GELEST Inc., trade name; SIM6492.72) was prepared.

### Production Examples 3 and 4

The reactions were performed in the same manner as in Production Example 1 except that the addition amount of KBE-9007 was doubled to synthesize the compound (Xcf1) and except that the addition amount of KBE-9007 was tripled to synthesize the compound (Xcf2), respectively.

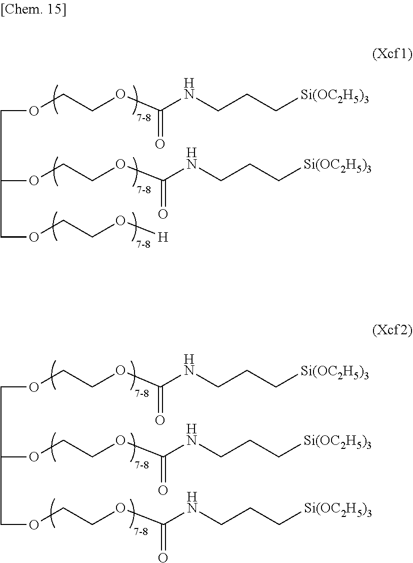

### Production Example 5

In Production Example 1, the following polyoxyethylene polyol B was used in place of polyoxyethylene polyol A, and was reacted with an equimolar amount of KBE-9007 in the same manner as described above, to obtain the compound (Xcf3).

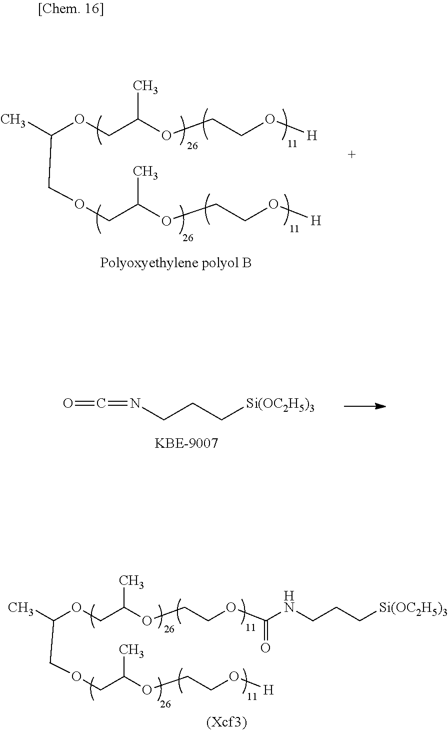

### Production Example 6

The reaction was performed in the same manner as in Production Example 5 except that the addition amount of KBE-9007 was doubled, to obtain the compound (Xcf4).

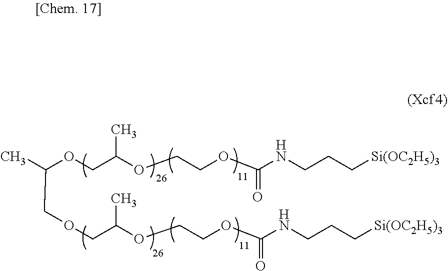

Table 1 shows the kind of polyoxyethylene polyol used in Production Examples 1 and 3 to 6 and the addition amount (equivalent amount) of KBE-9007 based on the polyoxyethylene polyol, and in the compounds obtained in Production Examples 1 to 6, Mw and the repeating number (n1) of (CH₂CH₂O) in the structure 1, the proportion of the structure 1 in the structure 4 among the structures 1 (% by mol) (shown as “proportion of the structure 4” in Table 1), the proportion (% by mass) of the biocompatible moiety (structure 1) in the compounds, and the proportion (% by mass) of the alkoxysilyl group.

TABLE 1

| Production Example | | | 1 | 2 | 3 | 4 | 5 | 6 |
|---|---|---|---|---|---|---|---|---|
| Compound abbreviation | | | (X12-1) | (X11-1) | (Xcf1) | (Xcf2) | (Xcf3) | (Xcf4) |
| Reaction | Kind of polyoxyethylene polyol | | A | Commercially | A | A | B | B |
| conditions | Amount (equivalent) of KBE-9007 with | | 1 | available product | 2 | 3 | 1 | 2 |
| | respect to polyoxyethylene polyol | | | | | | | |
| Compound | Mw | | 1260 | 590 | 1510 | 1760 | 4310 | 4560 |
| characteristics | n1 | | 7-8 | 9-12 | 7-8 | 7-8 | 11 | 11 |
| | Proportion of structure 4 | % by mol | 67 | 100 | 33 | 0 | 50 | 0 |
| | Proportion of biocompatible moiety | % by mass | 77.0 | 69.8 | 64.4 | 55.3 | 23.2 | 22.0 |
| | Proportion of alkoxysilyl group | % by mass | 12.9 | 20.5 | 21.6 | 27.8 | 3.8 | 7.2 |

| | | | | | | |
|---|---|---|---|---|---|---|
| Mw after partial hydrolysis and condensation | 2730 | 1210 | 4320 | 10600 | 8620 | 23700 |

### (Copolymer (X21))

As the compound (X2), copolymers (X21-1) to (X21-24) were produced according to the monomer compositions (mass ratios) and polymerization conditions shown in the following Table 2, and used. Furthermore, for Comparative Examples, copolymers (X21-cf1) and (X21-cf2) not satisfying the requirements as the compound (X) were similarly produced according to the monomer compositions and the polymerization conditions shown in Table 2. The monomers used and abbreviations thereof are shown below. As for the monomer composition shown in Table 2, for example, PME-200/KBM-503=95/5 in Production Example 6 indicates that PME-200 and KBM-503 were used at a mass ratio of 95:5. The same shall apply to other Production Examples.

### Monomer Abbreviations

### (1) (Meth)acrylate (A)

KBM-503: manufactured by Shin-Etsu Silicone Co., Ltd., product name, trimethoxysilylpropyl methacrylate (CH₂═C(CH₃)—COO—(CH₂)₃—Si(OCH₃)₃)
KBM-5103: manufactured by Shin-Etsu Silicone Co., Ltd., product name, trimethoxysilylpropyl acrylate (CH₂═CH—COO—(CH₂)₃—Si(OCH₃)₃)

### (2) (Meth)acrylate (B11)

PME-200: BLEMMER PME-200 (manufactured by NOF Corporation, trade name, CH₂═C(CH₃)—COO—(CH₂CH₂O)₄—CH₃)
PME-400: BLEMMER PME-400 (NOF Corporation, trade name, CH₂═C(CH₃)—COO—(CH₂CH₂O)₉—CH₃)
AME-400; BLEMMER AME-400 (NOF Corporation, trade name, CH₂═CH—COO—(CH₂CH₂O)₉—CH₃)
HEMA: CH₂═C(CH₃)—COO—CH₂CH₂O—H
HEA: CH₂═CH—COO—CH₂CH₂O—H

### (3) (Meth)acrylate (B2)

MPC: 2-methacryloyloxyethylphosphorylcholine (CH₂═C(CH₃)—COO—(CH₂)₂—(PO₄⁻)—(CH₂)₂—N⁺(CH₃)₃)

### (4) (Meth)acrylate (B3)

CBMA: 3-[[2-(methacryloyloxy)ethyl]dimethylammonio]propionate (CH₂═C(CH₃)—COO—(CH₂)₂—N⁺(CH₃)₂—CH₂—COO⁻)

### Production Example 7

Into a 500 mL-three-necked flask were added 57.0 g (206 mmol) of PME-200, 3.00 g (12.1 mmol) of KBM-503, 119 g of 1-methoxy-2-propanol, 21 g of diacetone alcohol, and 600 mg (2.61 mmol) of dimethyl 2,2′-azobis(2-methylpropionate) as a polymerization initiator. The monomer concentration in the reaction solution was controlled to 30% by mass, and the initiator concentration was controlled to 1% by mass. Subsequently, the obtained mixture was stirred at 75° C. under a nitrogen atmosphere for 16 hours, and then air-cooled to room temperature, to thereby obtain a colorless transparent liquid (a solution containing 30% by mass of the copolymer (X21-1)). The yield amount was 200 g, and the yield was 100%.

### Production Examples 8 to 28

Copolymers (X21-2) to (X21-22) were produced in the same manner as in Production Example 7 except that the monomer composition was changed as shown in Table 2.

### Production Example 29

Into a 100 mL-three-necked flask were added 7.0 g (23.7 mmol) of MPC, 3.00 g (12.1 mmol) of KBM-503, 40 g of ethanol, and 100 mg (0.43 mmol) of dimethyl 2,2′-azobis(2-methylpropionate) as a polymerization initiator. The monomer concentration in the reaction solution was controlled to 20% by mass, and the initiator concentration was controlled to 1% by mass. Subsequently, the obtained mixture was stirred at 75° C. under a nitrogen atmosphere for 16 hours, and then air-cooled to room temperature, to thereby obtain a colorless transparent liquid (a solution containing 20% by mass of the copolymer (X21-23)). The yield amount was 50 g, and the yield was 100%.

### Production Example 30

Copolymers (X21-24) was produced in the same manner as in Production Example 29 except that the monomer composition was changed as shown in Table 2.

### Production Examples 31 to 32

Copolymers (X21-cf1) to (X21-cf2) were produced in the same manner as in Production Example 7 except that the monomer composition was changed as shown in Table 2.

Table 2 shows Mw in the compounds (copolymers) obtained in Production Examples 7 to 32, the repeating number (n2) of (CH₂CH₂O) in the structure 1 (Production Examples 7 to 28 and Production Examples 30 to 32), the proportion (% by mass) of the biocompatible moieties (structure 1, structure 2 and structure 3) in the compounds, and the proportion (% by mass) of the alkoxysilyl group. Incidentally, the proportion (% by mol) of the structure 1 in the structure 4 among the structures 1 in the compounds (copolymers) obtained in Production Examples 7 to 28 and Production Examples 30 to 32 is all 100% by mol.

TABLE 2

| | | | Compound characteristics | | | | |
|---|---|---|---|---|---|---|---|
| | | | | | Proportion of | Proportion of | |
| | Compound | | | | biocompatible | alkoxysilyl | Mw after partial |
| Production | (copolymer) | Monomer composition | | | moiety | group | hydrolysis and |
| Example | abbreviation | (mass ratio) | Mw | n2 | (% by mass) | (% by mass) | condensation |
| 7 | (X21-1) | PME-200/KBM-503 = | 92400 | 4 | 66.1 | 2.4 | 189000 |
| | | 95/5 | | | | | |
| 8 | (X21-2) | PME-200/KBM-503 = | 91500 | | 62.6 | 4.9 | 219000 |
| | | 90/10 | | | | | |
| 9 | (X21-3) | PME-200/KBM-503 = | 93000 | | 59.1 | 7.3 | 223000 |
| | | 85/15 | | | | | |
| 10 | (X21-4) | PME-200/KBM-503 = | 93600 | | 55.6 | 9.8 | 235000 |
| | | 80/20 | | | | | |
| 11 | (X21-5) | PME-400/KBM-503 = | 94500 | 9 | 78.9 | 2.4 | 195000 |
| | | 95/5 | | | | | |
| 12 | (X21-6) | PME-400/KBM-503 = | 95600 | | 74.8 | 4.9 | 245000 |
| | | 90/10 | | | | | |
| 13 | (X21-7) | PME-400/KBM-503 = | 96200 | | 70.6 | 7.3 | 263000 |
| | | 85/15 | | | | | |
| 14 | (X21-8) | PME-400/KBM-503 = | 96300 | | 66.4 | 9.8 | 267000 |
| | | 80/20 | | | | | |
| 15 | (X21-9) | HEMA/KBM-503 = | 43200 | 1 | 43.8 | 2.4 | 93600 |
| | | 95/5 | | | | | |
| 16 | (X21-10) | HEMA/KBM-503 = | 44200 | | 41.5 | 4.9 | 93400 |
| | | 90/10 | | | | | |
| 17 | (X21-11) | HEMA/KBM-503 = | 43200 | | 39.2 | 7.3 | 94800 |
| | | 85/15 | | | | | |
| 18 | (X21-12) | HEMA/KBM-503 = | 46300 | | 36.9 | 9.8 | 102000 |
| | | 80/20 | | | | | |
| 19 | (X21-13) | HEMA/KBM-503 = | 47500 | | 34.6 | 12.2 | 116000 |
| | | 75/25 | | | | | |
| 20 | (X21-14) | HEMA/KBM-503 = | 47000 | | 32.3 | 14.6 | 121000 |
| | | 70/30 | | | | | |
| 21 | (X21-15) | HEMA/KBM-503 = | 48600 | | 30.0 | 17.1 | 123000 |
| | | 65/35 | | | | | |
| 22 | (X21-16) | HEMA/KBM-503 = | 47500 | | 27.7 | 19.5 | 134000 |
| | | 60/40 | | | | | |
| 23 | (X21-17) | HEMA/KBM-503 = | 49300 | | 25.4 | 22.0 | 146000 |
| | | 55/45 | | | | | |
| 24 | (X21-18) | AME-400/KBM-5103 = | 65200 | 9 | 82.9 | 2.6 | 135000 |
| | | 95/5 | | | | | |
| 25 | (X21-19) | AME-400/KBM-5103 = | 66300 | | 76.9 | 5.2 | 142000 |
| | | 90/10 | | | | | |
| 26 | (X21-20) | HEA/KBM-5103 = | 38500 | 1 | 49.1 | 2.6 | 71400 |
| | | 95/5 | | | | | |
| 27 | (X21-21) | HEA/KBM-5103 = | 39200 | | 46.5 | 5.2 | 72300 |
| | | 90/10 | | | | | |
| 28 | (X21-22) | HEMA/KBM-503 = | 51000 | | 23.1 | 24.4 | 151000 |
| | | 50/50 | | | | | |
| 29 | (X21-23) | MPC/KBM-503 = | not | — | 43.2 | 14.6 | not |
| | | 70/30 | measured | | | | measured |
| 30 | (X21-24) | CBMA/KBM-503 = | not | — | 33.2 | 14.6 | not |
| | | 70/30 | measured | | | | measured |
| 31 | (X21-cf1) | PME-200/KBM-503 = | 93200 | 4 | 69.6 | 0 | — |
| | | 100/0 | | | | | |
| 32 | (X21-cf2) | HEMA/KBM-503 = | 41000 | 1 | 46.1 | 0 | — |
| | | 100/0 | | | | | |

### Example 1

To a solvent prepared by mixing isopropyl alcohol (IPA) and a 0.1% by mass aqueous nitric acid solution at a mass ratio of 70:30 was added the compound (X12-1) so that the concentration of solid components was 30% by mass, followed by stirring at 50° C. for 16 hours, to obtain a liquid composition 1 containing a partially hydrolyzed condensate of the compound (X12-1). Table 1 shows Mw of the obtained partially hydrolyzed condensate. This condensate was directly used as the composition 1 for surface layer formation. Table 3 shows the proportion (% by mass) of the biocompatible moiety (structure 1) and the proportion (% by mass) of the alkoxysilyl group in the composition 1 for surface layer formation. Similarly, for Examples 2 to 10 and 12 to 14 described below, Table 3 shows the proportion (% by mass) of the biocompatible moiety (structure 1) and the proportion (% by mass) of the alkoxysilyl group in the composition for surface layer formation.

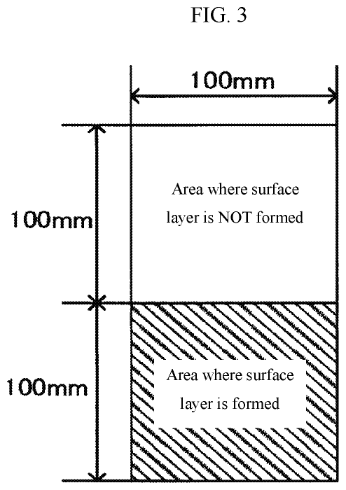

A glass plate (FL3, manufactured by AGC Inc., trade name, transparent float-soda lime glass) of 200 mm in length, 100 mm in widthand 3 mm in thickness was bisected by a straight line in the width direction. One area (100 mm in length and 100 mm in width) of the bisected glass was coated with the composition 1 for surface layer formation by a dipping method and after being allowed to stand at 25° C. for 15 minutes, the composition was cured at 120° C. for 1 hour. In this manner, as illustrated in FIG. 3, a glass plate 1 having a surface layer formed on a half area in a planar view (hereinafter, referred to as “surface layer-attached glass plate 1”. The same shall apply to the following.) was produced. The film thickness of the surface layer was controlled to 1000 nm. The film thickness was controlled to be the same in the following Examples 2 to 10 and 12 to 14.

### Examples 2 to 4 and 6

The liquid composition 1 containing a partially hydrolyzed condensate of the compound (X12-1) was obtained in the same manner as in Example 1. Furthermore, TEOS (tetraethoxysilane) was partially hydrolyzed and condensed in the same manner as in Example 1 to obtain a liquid composition 2 containing a partially hydrolyzed condensate (Mw: 1050) of TEOS. The liquid composition 1 and the liquid composition 2 were mixed so that the ratio of the partially hydrolyzed condensate of the compound (X12-1) to the partially hydrolyzed condensate of TEOS was as shown in Table 3, thereby obtaining compositions 2 to 4 and 6 for surface layer formation.

Glass plates 2 to 4 and 6 each having a surface layer formed on a half area in a planar view were produced in the same manner as in Example 1 by using the compositions 2 to 4 and 6 for surface layer formation, respectively.

### Example 5

A liquid composition 3 containing a partially hydrolyzed condensate of the compound (X11-1) was obtained in the same manner as in Example 1, except that the compound (X12-1) was changed to the compound (X11-1). Table 1 shows Mw of the obtained partially hydrolyzed condensate. The liquid composition 3 and the liquid composition 2 containing the partially hydrolyzed condensate of TEOS were mixed so that the ratio of the partially hydrolyzed condensate of the compound (X11-1) to the partially hydrolyzed condensate of TEOS was as shown in Table 3, thereby obtaining a composition 5 for surface layer formation.

A glass plate 5 having a surface layer formed on a half area in a planar view was produced in the same manner as in Example 1 by using the composition 5 for surface layer formation.

### Examples 7 to 10

Liquid compositions 7 to 10 respectively containing the partially hydrolyzed condensates of the compound (Xcf1) to the compound (Xcf4) were obtained in the same manner as in Example 1, except that the compound (X12-1) was changed to the compounds (Xcf1) to (Xcf4), respectively. Table 2 shows Mw of the obtained partially hydrolyzed condensates. The condensates were directly used as compositions 7 to 10 for surface layer formation.

Glass plates 7 to 10 each having a surface layer formed on a half area in a planar view were produced in the same manner as in Example 1 by using the compositions 7 to 10 for surface layer formation, respectively.

### Example 11

A glass plate (FL3, manufactured by AGC Inc., trade name, transparent float-soda lime glass) of 200 mm in length, 100 mm in width and 3 mm in thickness was directly used for evaluation.

### Example 12

A glass plate 12 having a surface layer formed on a half region in a planar view was produced in the same manner as in Example 1 by using KR-500 (manufactured by Shin-Etsu Silicone Co., Ltd., product name, methylmethoxysilicone, a 1-methoxy-2-propanol solution having a solid component concentration of 15% by mass) as a composition 12 for surface layer formation.

### Example 13

A glass plate 13 having a surface layer formed on a half region in a planar view was produced in the same manner as in Example 1 by using a 15% by mass solution of polyoxyethylene polyol A in 1-methoxy-2-propanol as a composition 13 for surface layer formation.

### Example 14

A glass plate 14 having a surface layer formed on a half region in a planar view was produced in the same manner as in Example 1 by using the same coating composition as in Example 1 of JP-A-2006-188591 as a composition 14 for surface layer formation.

### [Evaluation of Physical Properties]

The following evaluations were performed by using the surface layer-attached glass plates 1 to 14 obtained above. Table 3 shows the results. In Table 3, blank columns indicate “not measured”.

### (1) Elastic Modulus Decrease Rate (%)

After drying the surface layer-attached glass plates 1, 2, 4, 6, 8, and 11 to 13 under atmospheric pressure under conditions of 30% RH and 25° C. for 60 minutes, the elastic modulus of the surface layer was measured under the atmospheric conditions by the following method on the following apparatus (AFM). The obtained elastic modulus is defined as the elastic modulus A measured after drying in the air.

Next, a phosphate-buffered physiological saline solution was dropped onto the surface layer of each of the surface layer-attached glass plates 1, 2, 4, 6, 8, and 11 to 13 so that a droplet (convex meniscus) was formed. Then, the elastic modulus was measured by the following method using the following device (AFM). The obtained elastic modulus is defined as the elastic modulus B measured in water. The elastic modulus decrease rate was calculated by the following formula.

Elastic modulus decrease rate (%)=(Elastic modulus B/Elastic modulus A)×100

### <Method of Measuring Elastic Modulus>

Device (AFM): Cypher-S, manufactured by Oxford Instruments
Cantilever holder: Droplet cantilever holder
Probe: B20-NCHR-based HDCTIP (spherical tip, tip curvature: 20 nm, cantilever: type FM-AUD), manufactured by German Nanotools

At the time of measuring the elastic modulus, first, the optical lever sensitivity and the spring constant are calibrated by using a sapphire substrate measurement and a thermal noise method. The optical lever sensitivity is calculated by a force curve measurement on a sapphire substrate surface. Furthermore, while the probe is separated from a sample surface by about 1 mm and the calculated optical lever sensitivity is fixed, the spring constant is calculated by a thermal noise method.

Next, the surface shape of a sample is acquired by using the above-described device. Thereafter, the indentation position is determined with avoiding dust and the like, and a force curve measurement is performed. For the measurement, indentation is performed at a maximum pushing force of 200 nN and a pushing rate of 1 Hz. The elastic modulus is calculated by fitting the indentation curve with the Hertz model by using the analysis software (AR ver13) annexed to Cypher-S.

### (2) Water Resistance

According to the following evaluation criteria, cracks, presence or absence of interfacial peeling and white turbidity were evaluated after immersing the surface layer-attached glass plates 1 to 14 in the following test waters 1 to 4 at 25 to 30° C. for 30 days. Regarding the presence or absence of the interfacial peeling, a residual film was confirmed by determining the presence or absence of the peak of the urethane bond (—OOCNH—) around 1720 cm⁻¹ or the peak of a methylene group (C—C) around 2900 cm⁻¹ by using ATR-IR (Thermo Fishier Scientific Inc., IZ10). The presence or absence of the cracks and white turbidity was visually confirmed.

### (Test Water)

Test water 1: weakly acidic (test water prepared by bubbling carbon dioxide into tap water of pH=7.1 to 8.3 to adjust the pH to 6.0 to 7.0)
Test water 2: neutral (distilled water having a pH of about 7.0)
Test water 3: weakly basic (tap water having a pH of 7.1 to 8.3)
Test water 4: sea water (test water obtained by adding 4% by mass of “sea salt” (manufactured by Kamihata Fish Industries Ld., trade name) to tap water having a pH of 7.1 to 8.3)

### (Evaluation Criteria)

“A” (good): No crack, interfacial peeling nor white turbidity was observed in all of the test waters 1 to 4.
“B” (poor): Cracks, interfacial peeling or white turbidity were observed in any of the test waters 1 to 4.

### (3) Alga Adhesion Preventive Property

The surface layer-attached glass plates 1 to 12 and 14 was disposed on the inner wall surface of an aquarium (45 cm×27 cm×30 cm, made of glass) having the same shape as the aquarium main body of the aquarium illustrated in FIG. 1. Tap water (pH 7.1 to 8.3) was added and the alga adhesion preventive property was evaluated at the time when three goldfish were kept at a water temperature of 25 to 30° C. The surface layer-attached glass plates 1 to 12 and 14 were adhered to the inner wall surface of the aquarium with a sealant so that the whole of the glass plates were immersed in water. During the test, one 70 W-metal halide lamp was placed at a position 30 cm above the upper end of the aquarium and was turned on for 12 hours per day to irradiate the aquarium with light.

The appearance of the area on which the surface layer had been formed was visually observed two weeks after the algae started to adhere to the area on which the surface layer had not been formed, and the alga adhesion preventive property was evaluated according to the following evaluation criteria.

### (Evaluation Criteria)

“3”: Almost no algae is adhered.
“2”: Algae are adhered but the amount is less than that on the area where the surface layer had not been formed.
“1”, Algae are adhered on the surface layer in the same or more extent than the area where the surface layer had not been formed.

### (4) Alga Removal Property

In the above-described (3) Alga adhesion preventive property test, the surface layer-attached glass plates 1 to 12 and 14 were immersed in water until algae adhered to the area where the surface layer had been formed. The easiness of wiping off the algae adhered to the area where the surface layer had been formed (alga removal property) was evaluated according to the following evaluation criteria. A melamine sponge (1 cm×1 cm×1 cm) wetted with water was used for wiping, and the wiping was performed with a load of 200 to 300 g/cm.

### (Evaluation Criteria)

“3”: When flushed with running water, algae can be removed without wiping.
“2”: Algae can be removed with wiping once.
“1”: Algae can be only removed with wiping twice or more times.

TABLE 3

| | | | | | | | | Composition characteristics |
|---|---|---|---|---|---|---|---|---|
| | | | | | | | | Proportion of |
| | Composition of solid component (partially hydrolyzed condensate) of | | | | | | | biocompatible |
| | composition for surface layer formation [part by mass] | | | | | | | moiety |
| | (X12-1) | (X11-1) | (Xcf1) | (Xcf2) | (Xcf3) | (Xcf4) | TEOS | (% by mass) |
| Example 1 | 100 | 0 | 0 | 0 | 0 | 0 | 0 | 77.0 |
| Example 2 | 67 | 0 | 0 | 0 | 0 | 0 | 33 | 51.6 |
| Example 3 | 50 | 0 | 0 | 0 | 0 | 0 | 50 | 38.5 |
| Example 4 | 33 | 0 | 0 | 0 | 0 | 0 | 66 | 25.4 |
| Example 5 | 0 | 67 | 0 | 0 | 0 | 0 | 33 | 46.8 |
| Example 6 | 25 | 0 | 0 | 0 | 0 | 0 | 75 | 19.2 |
| Example 7 | 0 | 0 | 100 | 0 | 0 | 0 | 0 | 64.4 |
| Example 8 | 0 | 0 | 0 | 100 | 0 | 0 | 0 | 55.3 |
| Example 9 | 0 | 0 | 0 | 0 | 100 | 0 | 0 | 23.2 |
| Example 10 | 0 | 0 | 0 | 0 | 0 | 100 | 0 | 22.0 |

| | | |
|---|---|---|
| Example 11 | glass plate | — |
| Example 12 | KR-500 (methylmethoxysilicone) | 0 |
| Example 13 | polyoxyethylene polyol A | 95.7 |
| Example 14 | Example 1 of JP-A-2006-188591 | 1.4 |

| | | Evaluation | | | |
|---|---|---|---|---|---|
| | Composition characteristics | Elastic | | Alga | |
| | Proportion of | modulus | | adhesion | Alga |
| | alkoxysilyl group | decrease | Water | preventive | removal |
| | (% by mass) | ratio [%] | resistance | property | property |
| Example 1 | 12.9 | 0.1% | A | 3 | 2 |
| Example 2 | 41.6 | 4.5% | A | 3 | 2 |
| Example 3 | 56.5 | | A | 3 | 2 |
| Example 4 | 70.3 | 32.0% | A | 2 | 1 |
| Example 5 | 45.0 | | A | 3 | 2 |
| Example 6 | 78.2 | 66.0% | A | 1 | 1 |
| Example 7 | 21.6 | | A | 1 | 1 |
| Example 8 | 27.8 | 65.0% | A | 1 | 1 |
| Example 9 | 3.8 | | A | 1 | 1 |
| Example 10 | 7.2 | | A | 1 | 1 |
| Example 11 | — | 95.0% | A | 1 | 1 |
| Example 12 | 28 | 70.0% | A | 1 | 1 |
| Example 13 | 0 | <0.01% | B | | |
| Example 14 | 2.8 | | A | 1 | 1 |

### Examples 15 to 35, and 42

Solutions (solid component concentration: 30% by mass) respectively containing the copolymers (X21-1) to (X21-22) were added to a solvent prepared by mixing 1-methoxy-2-propanol, diacetone alcohol and a 0.1% by mass aqueous nitric acid solution at a mass ratio of 51:9:40 so that the solid component concentration was 15% by mass, followed by stirring at 50° C. for 16 hours to obtain liquid compositions 15 to 35 and 42 respectively containing the partially hydrolyzed condensates of the copolymers (X21-1) to (X21-22). Table 2 shows Mw of each of the resulting partially hydrolyzed condensates. They were directly used as the compositions 15 to 35 and 42 for surface layer formation. Table 4 shows the proportion (% by mass) of the biocompatible moiety (structure 1) and the proportion (% by mass) of the alkoxysilyl group in each composition for surface layer formation.

Glass plates 15 to 35 and 42 each having a surface layer formed on a half area in a planar view were produced in the same manner as in Example 1 by using the compositions 15 to 35 and 42 for surface layer formation, respectively.

### Examples 36 and 37

Solutions (solid component concentration: 20%) respectively containing the copolymers (X21-23) and (X21-24) were adjusted with a 0.1% by mass aqueous nitric acid solution so that the solid content concentration was 10% by mass, followed by stirring at 50° C. for 16 hours to obtain liquid compositions 36 and 37 respectively containing the partially hydrolyzed condensates of the copolymers (X21-23) and (X21-24). Table 2 shows Mw of each of the resulting partially hydrolyzed condensates. They were directly used as compositions 36 and 37 for surface layer formation. Table 4 shows the proportion (% by mass) of the biocompatible moiety (structure 2 or structure 3) and the proportion (% by mass) of the alkoxysilyl group in each of the compositions for surface layer formation.

Glass plates 36 and 37 each having a surface layer formed on a half region in a planar view were produced in the same manner as in Example 1 by using each of the compositions 36 and 37 for surface layer formation.

### Example 38

The liquid composition 24 containing the partially hydrolyzed condensate of the copolymer (X21-10) obtained above and the copolymer (X21-cf2) were mixed so that the solid component ratio of the partially hydrolyzed condensate of the copolymer (X21-10) to the copolymer (X21-cf2) was 1:1, and the solid component concentration of the whole was adjusted so as to be 15% by mass with a mixed solvent of 1-methoxy-2-propanol and diacetone alcohol, to thereby obtain a composition 38 for surface layer formation. Table 4 shows the proportion (% by mass) of the biocompatible moiety (structure 1) and the proportion (% by mass) of the alkoxysilyl group in the composition 38 for surface layer formation.

A glass plate 38 having a surface layer formed on a half area in a planar view was produced in the same manner as in Example 1 by using the composition 38 for surface layer formation.

### Example 39

A composition 39 for surface layer formation was obtained in the same manner as in Example 38 except that the solid component ratio of the partially hydrolyzed condensate of the copolymer (X21-10) to the copolymer (X21-cf2) was changed to 2:1, and a glass plate 39 having a surface layer formed on a half area in a planar view was produced in the same manner as in Example 1. Table 4 shows the proportion (% by mass) of the biocompatible moiety (structure 1) and the proportion (% by mass) of the alkoxysilyl group in the composition 39 for surface layer formation.

### Examples 40 and 41

The copolymer (X21-cf1) and the copolymer (X21-cf2) of 15% by mass 1-methoxy-2-propanol solutions were used as compositions 40 and 41 for surface layer formation, respectively, and glass plates 40 and 41 each having a surface layer formed on a half area in a planar view were produced in the same manner as in Example 1. Table 4 shows the proportion (% by mass) of the biocompatible moiety (structure 1) and the proportion (% by mass) of the alkoxysilyl group in the compositions 40 and 41 for surface layer formation.

### Examples 43 and 44

### (Production of Copolymer (Z1))

As the copolymer (Z1) satisfying the requirements for the compound (X3), a copolymer (X3-1) and a copolymer (X3-2) were produced as follows.

### (Copolymer (X3-1))

Into a 500 mL-three-necked flask were added 45.0 g (346 mmol) of HEMA, 3.00 g (12.1 mmol) of KBM-503, 119 g of 1-methoxy-2-propanol, 21 g of diacetone alcohol, and 12 g of VPE-0201 (manufactured by Wako Pure Chemical Industries Inc., trade name, a compound where n3 is 45 to 46 and n4 is 6 to 14 in the compound (PI)) as a polymerization initiator (5.4 mmol as an azo group). Subsequently, the obtained mixture was stirred at 80° C. under a nitrogen atmosphere for 16 hours, and then air-cooled to room temperature, to thereby obtain a colorless transparent liquid (a solution containing 30% by mass of the copolymer (X3-1) where, in a copolymer (X3-Z1) represented by the following formula (X3-Z1), f1 was 95, e1 was 3 and j1 was 2). The yield amount was 200 g, and the yield was 100%.

A liquid composition containing a partially hydrolyzed condensate of the copolymer (X3-1) was obtained in the same manner as in Examples 15 to 35 and 42 by using the obtained colorless transparent liquid. The liquid composition was directly used as a composition 43 for surface layer formation.

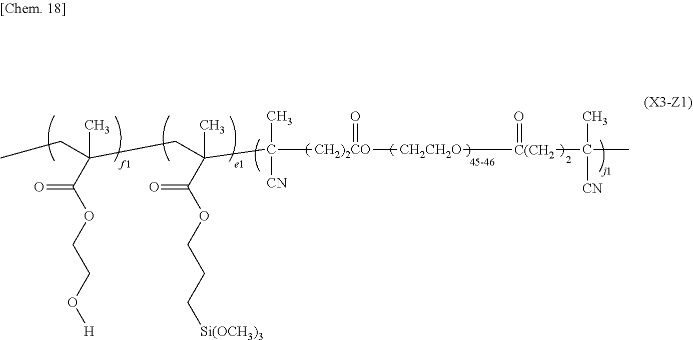

In the copolymer (X3-1), Mw is 28,500, Mw of the obtained partially hydrolyzed condensate is 52,100, the proportion of the structure 1 in the structure 4 among the structures 1 is 98% by mol, the proportion of the biocompatible moiety (structure 1) is 52.3% by mass, and the proportion of the alkoxysilyl groups is 2.4% by mass.

### (Copolymer (X3-2))

A copolymer (X3-2) where f1 was 91, e1 was 7 and j1 was 2 in the copolymer (X3-Z1) was produced as a colorless transparent liquid (a solution containing 30% by mass of the copolymer (X3-2)) in the same manner as in the production of the above-described copolymer (X3-1), except that the mass of HEMA was changed to 42.0 g and the mass of KBM-503 was changed to 6.0 g. The yield amount was 200 g, and the yield was 100%. A liquid composition containing a partially hydrolyzed condensate of the copolymer (X3-2) was obtained in the same manner as in Examples 15 to 35 and 42 by using the obtained colorless transparent liquid. The liquid composition was directly used as the composition 44 for surface layer formation.

In the copolymer (X3-2), Mw is 29,600, Mw of the obtained partially hydrolyzed condensate is 54,600, the proportion of the structure 1 in the structure 4 among the structures 1 is 98% by mol, the proportion of the biocompatible moiety (structure 1) is 50.0% by mass, and the proportion of the alkoxysilyl groups is 4.9% by mass.

### (Production of Surface Layer-attached Glass Plates 43 and 44)

Glass plates 43 and 44 each having a surface layer formed on a half area in a planar view were produced in the same manner as in Examples 15 to 35 and 42 by using the obtained compositions 43 and 44 for surface layer formation, respectively.

### [Evaluation of Physical Properties]

The same evaluations as those in Examples 1 to 14 described above were performed by using the surface layer-attached glass plates 15 to 44 obtained above. Table 4 shows the results. In Table 4, blank columns indicate “not measured”.

In the evaluation of water resistance, for the presence or absence of interfacial peeling, a residual film was confirmed by determining the presence or absence of the peak of an ester bond (—COO—) around 1723 cm⁻¹ by using ATR-IR (Thermo Fisher Scientific Inc., IZ10).

TABLE 4

| | | Composition characteristics | | Evaluation | | | |
|---|---|---|---|---|---|---|---|
| | | Proportion of | Proportion of | Elastic | | Alga | |
| | Partially | biocompatible | alkoxysilyl | modulus | | adhesion | Alga |
| | hydrolyzed | moiety | group | decrease | Water | preventive | removal |
| | condensate | (% by mass) | (% by mass) | ratio [%] | resistance | property | property |
| Ex. 15 | (X21-1) | 66.1 | 2.4 | 63.0% | A | 2 | 3 |
| Ex. 16 | (X21-2) | 62.6 | 4.9 | 20.0% | A | 2 | 3 |
| Ex. 17 | (X21-3) | 59.1 | 7.3 | | A | 2 | 3 |
| Ex. 18 | (X21-4) | 55.6 | 9.8 | | A | 2 | 2 |
| Ex. 19 | (X21-5) | 78.9 | 2.4 | | A | 2 | 3 |
| Ex. 20 | (X21-6) | 74.8 | 4.9 | 37.0% | A | 2 | 3 |
| Ex. 21 | (X21-7) | 70.6 | 7.3 | | A | 2 | 3 |
| Ex. 22 | (X21-8) | 66.4 | 9.8 | | A | 2 | 2 |
| Ex. 23 | (X21-9) | 43.8 | 2.4 | 13.0% | A | 3 | 3 |
| Ex. 24 | (X21-10) | 41.5 | 4.9 | 31.0% | A | 2 | 3 |
| Ex. 25 | (X21-11) | 39.2 | 7.3 | | A | 2 | 3 |
| Ex. 26 | (X21-12) | 36.9 | 9.8 | 39.0% | A | 2 | 3 |
| Ex. 27 | (X21-13) | 34.6 | 12.2 | | A | 2 | 2 |
| Ex. 28 | (X21-14) | 32.3 | 14.6 | | A | 2 | 2 |
| Ex. 29 | (X21-15) | 30.0 | 17.1 | 47.0% | A | 2 | 1 |
| Ex. 30 | (X21-16) | 27.7 | 19.5 | | A | 2 | 1 |
| Ex. 31 | (X21-17) | 25.4 | 22.0 | 60.0% | A | 2 | 1 |
| Ex. 32 | (X21-18) | 82.9 | 2.6 | | A | 2 | 2 |
| Ex. 33 | (X21-19) | 76.9 | 5.2 | | A | 2 | 2 |
| Ex. 34 | (X21-20) | 49.1 | 2.6 | | A | 2 | 2 |
| Ex. 35 | (X21-21) | 46.5 | 5.2 | 25.0% | A | 2 | 2 |
| Ex. 36 | (X21-23) | 43.2 | 14.6 | | A | 3 | 3 |
| Ex. 37 | (X21-24) | 33.2 | 14.6 | | A | 3 | 3 |
| Ex. 38 | Mixture of (X21-10) | 43.8 | 2.4 | 13.0% | A | 3 | 3 |
| | and (X21-cf2) | | | | | | |
| | in mass ratio of 1:1 | | | | | | |
| Ex. 39 | Mixture of (X21-10) | 43.0 | 3.3 | 17.0% | A | 3 | 3 |
| | and (X21-cf2) | | | | | | |
| | in mass ratio of 2:1 | | | | | | |
| Ex. 40 | (X21-cf1) | 69.6 | 0 | <0.01% | B | | |
| Ex. 41 | (X21-cf2) | 46.1 | 0 | 0.01% | B | | |
| Ex. 42 | (X21-22) | 23.1 | 24.4 | 67.0% | A | 1 | 1 |
| Ex. 43 | (X3-1) | 52.3 | 2.4 | | A | 3 | 3 |
| Ex. 44 | (X3-2) | 50.0 | 4.9 | 16.0% | A | 3 | 3 |

While the present invention has been described in detail and with reference to specific embodiments thereof, it will be apparent to one skilled in the art that various changes and modifications can be made therein without departing from the spirit and scope thereof. The present application is based on Japanese Patent Application (No. 2018-016738) filed on Feb. 1, 2018 and Japanese Patent Application (No. 2018-123479) filed on Jun. 28, 2018, and the contents thereof are incorporated herein by reference.

### INDUSTRIAL APPLICABILITY

When the base material of the present invention is used, for example, in the case where the base material is used for an aquarium, adhesion of algae is suppressed on the surface that comes into contact with water in the aquarium, and since the suppressing action is durable, the effect of alga resistance is maintained even in long-term use. In an aquarium in which algae is likely to be generated, specifically, an aquarium having such a configuration that at least a part of a water-housing portion of the aquarium transmits light, an aquarium for keeping ornamental or edible living organisms, particularly, the effect of alga resistance can be continuously exhibited.

When the composition of the present invention is used, the effect of alga resistance can be also exhibited by applying the composition to ship bottoms, pipes, pools, waterways, and overflow plates.

The copolymer of the present invention can be used for surface treatment of a base material. The copolymer of the present invention can be used alone or in combination with other compounds, for surface treatment for suppressing adhesion of algae, and is suitable for surface treatment of the surface that comes into contact with water in an aquarium or the like.

### DESCRIPTION OF REFERENCE NUMERALS AND SIGNS

1: Aquarium (base material), 10: Aquarium main body (base material main body), 11: Bottom plate, 12: Wall plate, 21: Surface layer.

1. A base material that comes into contact with water, comprising a base material main body and a surface layer provided on at least a part of a surface that comes into contact with water of the base material main body,
wherein the surface layer is composed of a cured product of a composition containing a compound having a biocompatible moiety and a reactive silyl group,
the biocompatible moiety is composed of at least one selected from the group consisting of a structure represented by the following formula 1, a structure represented by the following formula 2 and a structure represented by the following formula 3,
the composition has a content of the biocompatible moiety being 25 to 83% by mass and a content of the reactive silyl group being 2 to 70% by mass, in a solid component, and
in the case where the biocompatible moiety has the structure represented by the following formula 1, 50 to 100% by mol of the structure represented by the following formula 1 is the structure represented by the following formula 1 in a structure represented by the following formula 4: 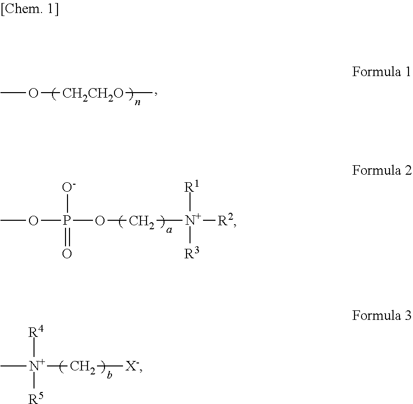
wherein, in the formula 1, n is an integer of 1 to 300;
in the formula 2, R¹ to R³ are each independently an alkyl group having a carbon number of 1 to 5, and a is an integer of 1 to 5; and
in the formula 3, R⁴ and R⁵ are each independently an alkyl group having a carbon number of 1 to 5, X⁻ is a group represented by the following formula 3-1 or a group represented by the following formula 3-2, and b is an integer of 1 to 5: 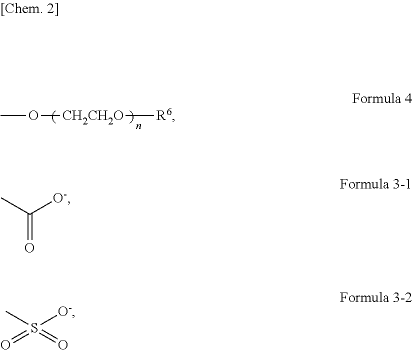
wherein, in the formula 4, n is an integer of 1 to 300 and R⁶ is a hydrogen atom or an alkyl group having a carbon number of 1 to 5.

2. The base material according to claim 1,
wherein the compound is a compound where the reactive silyl group is introduced so as to be bonded to a polyoxyethylene polyol or a polyoxyethylene polyol alkyl ether having at least one hydroxyl group (where the alkyl has a carbon number of 1 to 5) via an oxygen atom derived from the hydroxyl group or via a linking group in which the oxygen atom derived from the hydroxyl group is bonded to —(CH₂)ₖ—, —CONH(CH₂)ₖ—, —CON(CH₃)(CH₂)ₖ—, —CON(C₆H₅)(CH₂)ₖ—, —(CF₂)ₖ—, —CO(CH₂)ₖ—, —CH₂CH(—OH)CH₂O(CH₂)ₖ— (k represents an integer of 2 to 4), —CH₂OC₃H₆—, or —CF₂OC₃H₆—.

3. The base material according to claim 1,
wherein the compound is a copolymer having a unit based on a (meth)acrylate having the structure represented by the formula 1 (where 50 to 100% by mol thereof is the structure represented by the formula 1 in the structure represented by the formula 4) and a unit based on a (meth)acrylate having the reactive silyl group.

4. The base material according to claim 1,
wherein the compound is a copolymer having a unit based on a (meth)acrylate having the structure represented by the formula 1 (where 50 to 100% by mol thereof is the structure represented by the formula 1 in the structure represented by the formula 4), a unit based on a (meth)acrylate having the reactive silyl group and a unit represented by a formula (B12): 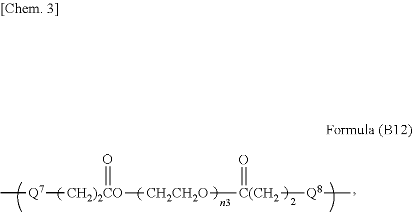
wherein, in the formula (B12), Q⁷ and Q⁸ are each independently a divalent organic group, and n3 is an integer of 20 to 200.

5. The base material according to claim 1,
wherein the composition contains: a copolymer having a unit based on a (meth)acrylate having the structure represented by the formula 1 and a unit based on a (meth)acrylate having the reactive silyl group; and a polymer composed only of a unit based on a (meth)acrylate having the structure represented by the formula 1, and
50 to 100% by mol of the structure represented by the formula 1 contained in the solid component of the composition is the structure represented by the formula 1 in the structure represented by the formula 4.

6. The base material according to claim 5,
wherein the base material main body has a constituent material of glass.

7. An aquarium comprising the base material as described in claim 1 in at least a part thereof.

8. A base material that comes into contact with water, comprising a base material main body and a surface layer provided on at least a part of a surface that comes into contact with water of the base material main body,
wherein the surface layer has an elastic modulus measured by an atomic force microscope, and the elastic modulus shows a measured value in water being 0.1% to 63% with respect to a measured value after drying in the air.

9. An aquarium comprising the base material as described in claim 8 in at least a part thereof.

10. A copolymer comprising a unit represented by the following formula (A), a unit represented by the following formula (B11) and a unit represented by the following formula (B12): 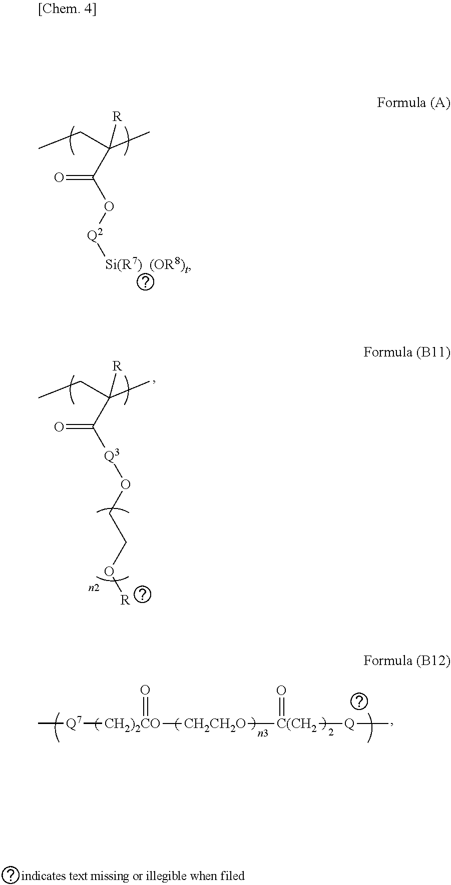
wherein, the symbols in the formula (A), the formula (B11) and the formula (B12) are as follows:
in the formulas (A) and (B11), R represents a hydrogen atom or a methyl group;
in the formula (A), Q² is a divalent organic group, R⁷ is an alkyl group having a carbon number of 1 to 18, and R⁸ is a hydrogen atom or an alkyl group having a carbon number of 1 to 18, t is an integer of 1 to 3, and in the case where a plurality of R⁷'s and OR⁸'s are present, the R⁷'s and the R⁸'s may be individually the same as or different from each other;
in the formula (B11), Q³ is a single bond or a divalent organic group, n2 is an integer of 1 to 300, and R⁶ is a hydrogen atom or an alkyl group having a carbon number of 1 to 5; and
in the formula (B12), Q⁷ and Q⁸ are each independently a divalent organic group, and n3 is an integer of 20 to 200.

11. The copolymer according to claim 10, satisfying a relationship of 1>f1/(f1+j1)≥0.5, when the total number of all units in the copolymer is defined 100 and when the number of units represented by the formula (B11) is denoted f1 and the number of units represented by the formula (B12) is denoted j1.

12. A composition comprising the copolymer as described in claim 10.
